(19) United States
(12) Patent Application Publication
(10) Pub. No.: US 2018/0096290 A1
(43) Pub. Date: Apr. 5, 2018

(54) SHARING INVENTORY BETWEEN ORDERING CHANNELS

(71) Applicant: Amazon Technologies, Inc., Seattle, WA (US)

(72) Inventors: Hernan P. Awad, Bellevue, WA (US); Ehsan Amiri, Seattle, WA (US); Deepak Bhatia, Issaquah, WA (US); Ali Sadighian, Seattle, WA (US); Tolga Han Seyhan, Seattle, WA (US); Nicholas Deming Sherman, Seattle, WA (US)

(21) Appl. No.: 14/579,505

(22) Filed: Dec. 22, 2014

(51) Int. Cl. G06Q 10/08; G06Q 30/06

(52) U.S. Cl. CPC G06Q 10/087; G06Q 30/0635

(57) ABSTRACT

Techniques for generating a decision to store units of an item may be provided. The units of the item may be offered from a network-based resource. For example, a first ordering channel and a second ordering channel may be provided to facilitate orders of the item from the network-based resource. The first and second ordering channels may allow random orders and deterministic orders of the item, respectively. Additionally, a value of a look ahead window associated with the second ordering channel may be accessed. The value may shift a time for an automatic generation of a deterministic order. Further, a first loss and a second loss may be computed based on the value. The first and second losses may be associated with losing a random order and losing the deterministic order, respectively. The decision may be generated based at least in part on the first loss and the second loss.

### BACKGROUND

More and more users are turning to network-based resources, such as electronic marketplaces, to purchase items (e.g., goods and/or services). A network-based resource may provide a user experience unmatched by a more traditional brick and mortar store. For example, the network-based resource may offer a larger and more diverse selection of items. Further, for some of the items, there may be a number of sellers with different offers. As such, a consumer may not only have access to a rich item selection, but may also obtain items at the most convenient offers.

Typically, a service provider may manage a network-based resource. For example, the service provider may allow sellers to offer items at the network-based resource. For some of the offered items, the service provider may store units of the offered items in storage. Doing so may allow offering these items as available from the storage. Thus, when a consumer operates a computing device to access the network-based resource, an indication may be presented that an offered item may be available from the storage.

### BRIEF DESCRIPTION OF THE DRAWINGS

Various embodiments in accordance with the present disclosure will be described with reference to the drawings, in which:

FIG. 1 is a block diagram illustrating an example environment for offering items at a network-based resource, according to embodiments;

FIG. 2 is a block diagram illustrating example channels associated with offering items, according to embodiments;

FIG. 3 is a block diagram illustrating example parameters of channels associated with offering items, according to embodiments;

FIG. 4 illustrates an example network-based resource in association with an electronic marketplace for offering items, according to embodiments;

FIG. 5 illustrates an example architecture for providing a network-based resource, according to embodiments;

FIG. 6 is a flow diagram illustrating an example process for sharing an inventory between channels, according to embodiments;

FIG. 7 is a flow diagram illustrating an example process for determining a quantity of an item to be inventoried, according to embodiments;

FIG. 8 is a flow diagram illustrating another example process for sharing an inventory between channels, according to embodiments;

FIG. 9 is a flow diagram illustrating another example process for determining a quantity of an item to be inventoried, according to embodiments;

FIG. 10 illustrates an example parameter for dividing an inventory order, according to embodiments;

FIG. 11 is a flow diagram illustrating an example process for dividing an inventory order, according to embodiments; and

FIG. 12 is a block diagram illustrating a computing environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, enhancing item inventory planning In particular, a network-based resource, such as an electronic marketplace, may offer items to consumers. Some of the items may be inventoried. Inventoried items may be offered as available from an inventory or storage associated with the network-based resource. Such offers may provide various incentives to consumers. For example, a consumer may decide to obtain an item available from the inventory over another similar item offered from another source. To decide on a number of units of an item that should be inventoried, an inventory decision may consider multiple parameters. The parameters may include, for example, a unit cost associated with a per unit cost of the item, a holding cost associated with a cost for storing the item in the inventory, a consumer in stock value associated with a long term value for presenting an indication to consumers that the item may be available from the inventory, revenue, and other parameters as further described herein below. Inventorying units of an item may also facilitate various ordering channels to offer inventoried items. For example, a first ordering channel may allow a consumer to order (e.g., purchase) an item from the inventory at any point in time if the inventory contains sufficient units of the item. A second ordering channel may allow a consumer to subscribe to the item (e.g., to automatically purchase the item at recurring time intervals). Thereafter, automatic orders may be placed on behalf of the consumer based on the subscription. Because the two ordering channels may be of different types, different consumer interactions may result. For example, random orders may be observed at the first ordering channel. In comparison, deterministic orders based on subscriptions may be observed at the second ordering channel. Accordingly, inventorying units of an item to be shared between both ordering channels may also need to consider parameters specific to both ordering channels.

In an embodiment, units of an item may be inventoried and shared between two ordering channels of different characteristics. One ordering channel may allow random orders, whereas another ordering channel may allow deterministic orders. To efficiently share the inventory, a decision may be generated to store a number of the units over a planning horizon. The decision may be based on a number of parameters. For example, an expected amount of random orders to be received during the planning horizon may be computed based on historical data. An amount of deterministic orders over the planning horizon may also be computed based on a look ahead window. This look ahead window may move ahead a time for generating automatic orders on behalf of subscribed consumers, thereby providing an advanced forecast of the amount of deterministic orders. The two amounts may be used in various ways to generate the decision to inventory the number of units of the item. In one example, the two amounts may be used to compute a stock-out time. The stock-out time may be a point in time during the planning horizon after which no units would remain available from the inventory. Accordingly, a loss may be computed based on a potential of canceling automatic orders for subscribed consumers between the stock-out time and an end of the planning horizon. Similarly, another loss may be computed based on a potential of losing random orders during that time frame. These two losses may be balanced against another set of parameters, such as a holding cost and revenue, to determine an optimum quantity to store. Accordingly, the decision may be generated to inventory that quantity. In another example of generating the decision, the two amounts may be added to generate a total amount. Further, padding may be added to the total amount to ensure that a service level associated with, for instance, the deterministic ordering channel may be met. In particular, because one of the amounts may be based on expected random orders and because the inventory may be shared, the randomness and the sharing may introduce variability and uncertainty that may impact the service level of the deterministic ordering channel. To mitigate this impact, the padding may be used. The padding may be computed based on, for example, the loss associated with the potential of canceling automatic orders for subscribed customers. Accordingly, the decision may be generated and may set the sum of the padding and the total amount as the quantity of the item to be inventoried.

To illustrate, consider an example of diapers offered at an electronic marketplace. The electronic marketplace may allow a consumer to subscribe to an automatic ordering of a certain quantity of diapers on a monthly basis. The electronic marketplace may also allow another consumer to purchase the quantity or another quantity of diapers at any point in time. Regardless of what ordering channels may be used to offer the diapers, a service provider of the electronic marketplace may store units of the diapers in storage to facilitate the ordering channels. On a weekly basis, a decision may be made to store a particular quantity of the diapers in the storage so that the diapers may be available for ordering in the upcoming week from the storage. To do so, the service provider may turn to an inventory management service. The inventory management service may implement a ten day look ahead window and may forecast or receive, from another computing service, a forecast of random orders for diapers. Thus, the inventory management service may compute a quantity of diapers needed to support subscribed consumers in the upcoming week based on the ten day look ahead window. Similarly, the inventory management service may compute another quantity of diapers needed to support random orders based on the forecast. Using these two quantities, the inventory planning service may compute the particular quantity of the diapers and generate a decision to store the particular quantity in the storage.

In the interest of clarity of explanation, various embodiments illustrated herein describe a regular channel and a subscription channel. A regular channel may be an example of an ordering channel that may facilitate random orders. A subscription channel may be an example of an ordering channel that may facilitate deterministic orders. However, the embodiments may not be limited to regular and subscription channels. Instead, the embodiments may similarly apply to ordering channels of different types, such as random and deterministic-based channels. In particular, embodiments herein may allow an inventory to be shared between two or more ordering channels of different types or having different characteristics, without reserving a portion of the inventory to a particular ordering channel and without adversely impacting individual service levels (e.g., quality of service) of the ordering channels. These and other features are further illustrated in the figures and next paragraphs.

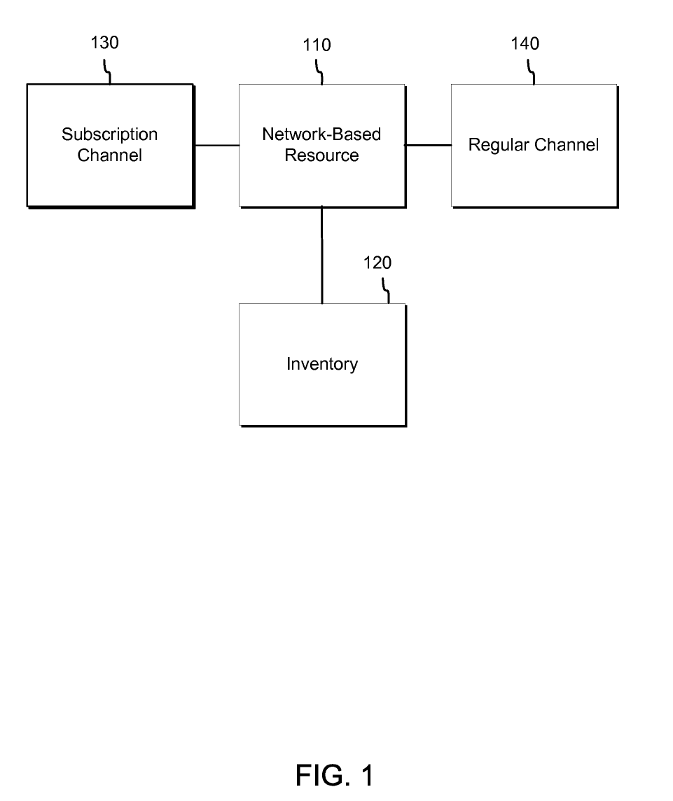

Turning to FIG. 1, the figure illustrates an example environment for offering items. More particularly, the illustrated environment may support a network-based resource 110, such as an electronic marketplace. The network-based resource 110 may facilitate a subscription channel 130 and a regular channel 140 to offer items as available from an inventory 120. The inventory 120 may be associated with the network-based resource 110. For example, a service provider may manage the network-based resource 110 and the inventory 120. This may include obtaining units of the items from suppliers, sellers, merchants, vendors, or other sources and storing the units in the inventory 120. The network-based resource 110 may present an indication to users (e.g., consumers, potential customers) that the items may be available from the inventory 120. In turn, the users may use the subscription channel 130 and/or the regular channel 140 to order items available from the inventory 120.

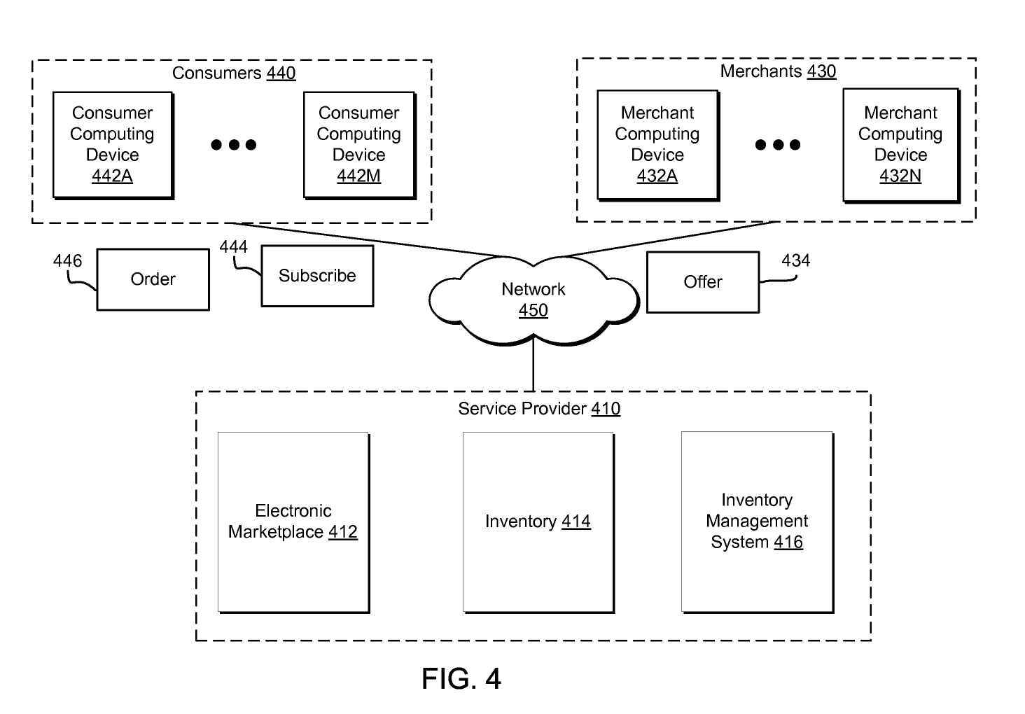

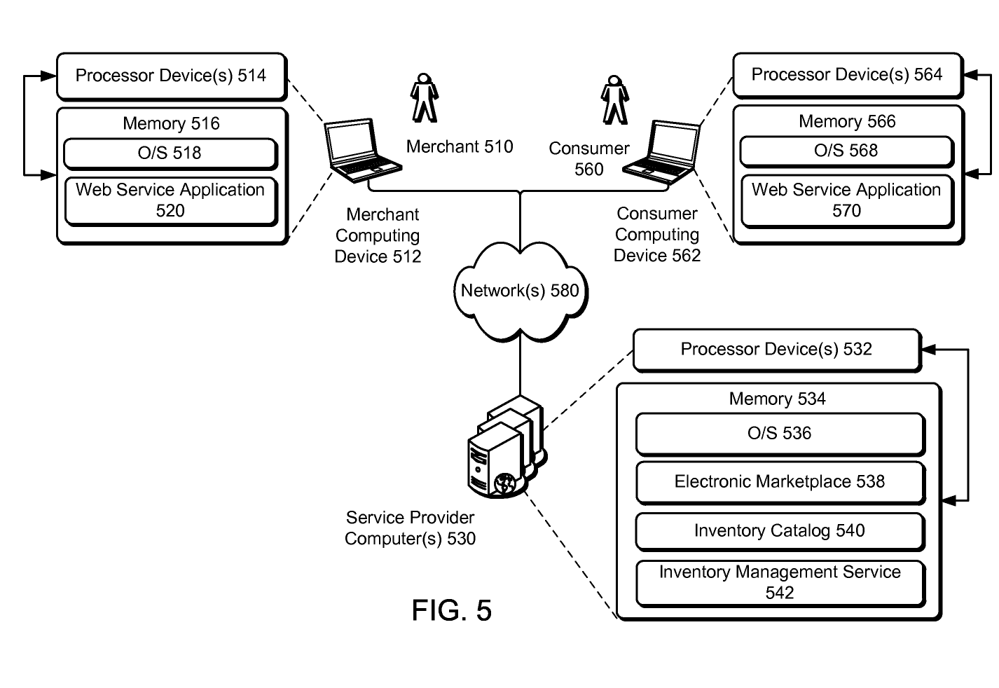

In an embodiment, the service provider may operate the network-based resource 110 to provide various types of services. Generally, the network-based resource may provide network pages or documents, such as web pages, associated with and/or describing the items offered through a marketplace (“item pages” or “item detail pages”). An item page may include information about an item, such as descriptions of the item, related offers, identifiers of suppliers of the item, and other information. Among this information, the item page may display an in-stock attribute for the item. An in-stock attribute may represent an indication that the item may be or is about to be available in the inventory 120. In comparison, if the item is not available, the item page may display an out-of-stock attribute. An example network-based resource is further illustrated in FIGS. 4-5.

The inventory 120 may represent a warehouse, a fulfillment center, a data center, a content distribution center, or some other storage resource for storing items. An item may represent a tangible item (e.g., consumer goods such as diapers) or an intangible item (e.g., a service, a multimedia content stored on a computer memory). Typically, an inventory management system may control operations of the inventory 120. An example inventory management system is further described in FIGS. 4-5. In an example, the service provider may operate the inventory management system. For instance, various entities or organizations represented by the service provider may provide input to and receive output from the inventory management system.

To illustrate, a manager of a particular item category (e.g., diapers) may use the inventory management system to search and find the number of inventoried items of that category and to input data related to a capacity to store additional items in the inventory 120. In another example, suppliers and/or third parties may additionally or alternatively operate the inventory management system. For instance, the suppliers may input information in the inventory management system describing the various available items, lead times, capacity to provide the items, and other supplier related information.

Consumers may operate computing devices to access the network-based resource over a network. This access can include various types of interactions, such as browsing, searching, purchasing, returning, and/or reviewing items. In particular, a consumer may access an item page associated with an item, review the information about the item, and make a purchasing decision. As part of the purchase decision, the consumer may consider the in-stock attribute. For example, the consumer may be enticed to purchase the in-stock item over an out-of-stock item because of the potentially shorter delivery time.

As illustrated in FIG. 1, the network-based resource 110 may provide a subscription channel 130 and a regular channel 140 to the consumers. The two ordering channels may be of different types (e.g., have different characteristics) and may allow the consumers different functionalities associated with ordering items. On one hand, the subscription channel 130 may allow a consumer, operating a computing device, to access the network-based resource and subscribe to one or more items. A subscription to an item may include signing up to recurring and automatic orders of the item. In other words, there may be a one-time subscription to the item by way of the subscription channel 130. Subsequently, automatic orders may be generated internally to the network-based resource 110 at recurring time intervals to deliver subscribed unit(s) of the item to the consumer. The automatic orders may be placed on behalf of the consumer without further input of the consumer. An automatic order may result in a subscribed unit(s) of the item delivered to a location associated with the consumer and in a charge applied to a consumer account. On the other hand, the regular channel 140 may allow a consumer, operating a computing device, to access the network-based resource and order an item (or a certain quantity of the item). The order may be placed by the consumer at any point in time and typically may be a one-time order independent of past or potential future orders of the consumer. In particular, if the item is available in-stock, the order may be processed internally to the network-based resource 110 and may result in a delivery of ordered unit(s) item and a charge to the consumer. If the item is out-of-stock, the consumer may select and order another item. Additionally or alternatively, the regular channel 140 may allow the consumer to order the out-of-stock item with an indication that the delivery of the item may be delayed until the item may become available from the inventory 120.

To illustrate, consider an example of diapers. In this example, the network-based resource 110 may offer a particular brand of diapers. A consumer may subscribe to a monthly delivery of a certain quantity of diapers of the particular brand by way of the subscription channel 130. The consumer subscription may occur once. However, on a monthly basis, automatic orders may be generated on behalf of the consumers based on the subscribed quantity. The automatic orders may result in recurring monthly deliveries of the subscribed quantity to the consumer. In comparison, another consumer may place a one-time order for another quantity of the diapers by way of the regular channel 140. As a result, the consumer order may be processed internally to the network-based resource 110 and may result in a one time delivery of the ordered quantity. In this case, if the consumer desires additional units of the diapers, the consumer may use the regular channel 140 to place another order or the subscription channel 130 to subscribe to recurring, automatic orders.

As such, the two ordering channels provide different functionalities to consumers. The different functionalities may also result in different characteristics of the ordering channels. In particular, the subscription channel 130 may represent an example of a deterministic ordering channel. A deterministic ordering channel may be associated with minimal or no variability in orders (representing a deterministic demand based on subscriptions). Because subscriptions may be used, the resulting recurring and automatic orders may be deterministic. In other words, the service provider of the network-based resource 110 may be able to estimate, with minimal uncertainty if any, an amount of automatic orders that should be placed on behalf of subscribed orders during a certain time period. In comparison, the regular channel may represent an example of a random ordering channel. A random ordering channel may be associated with random or variable orders (representing random or variable demand). Because consumers can order items at any point in time and/or in any quantities, the resulting orders may be random or highly variable. As such, the service provider may not be able to estimate, without an uncertainty, an amount of random orders expected to be received during a time period. Instead, estimations with different levels of variability may be generated. For example, different potential realizations of consumer demand over the regular channel may be generated based on historical data.

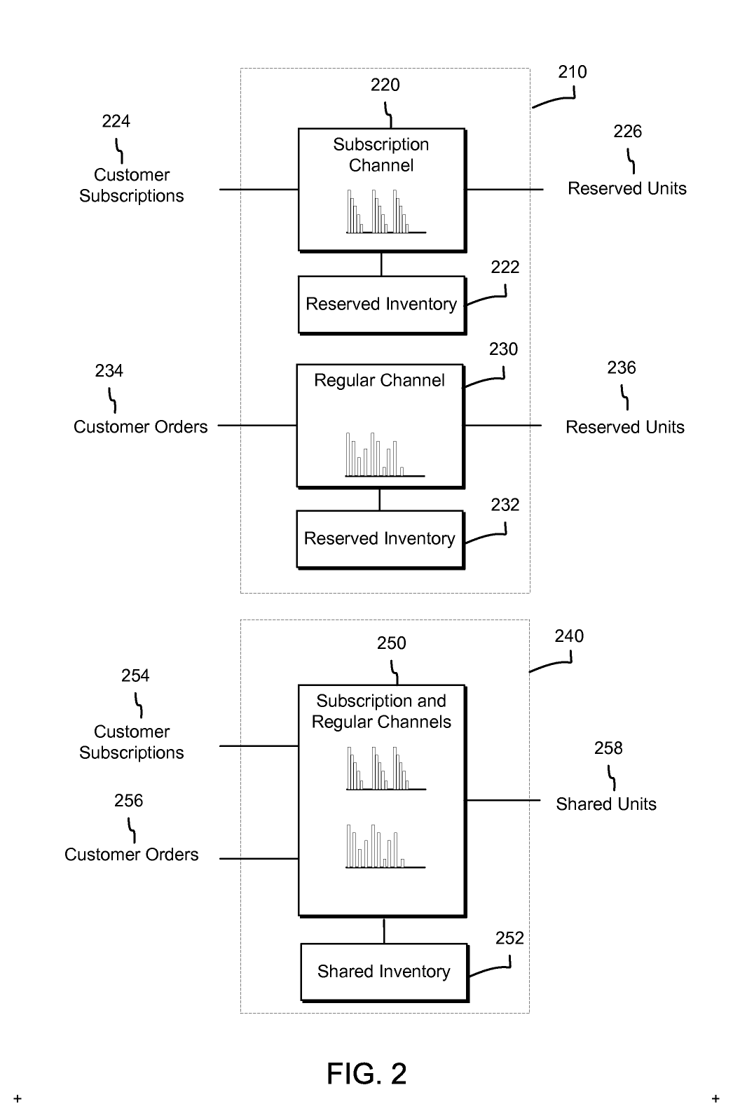

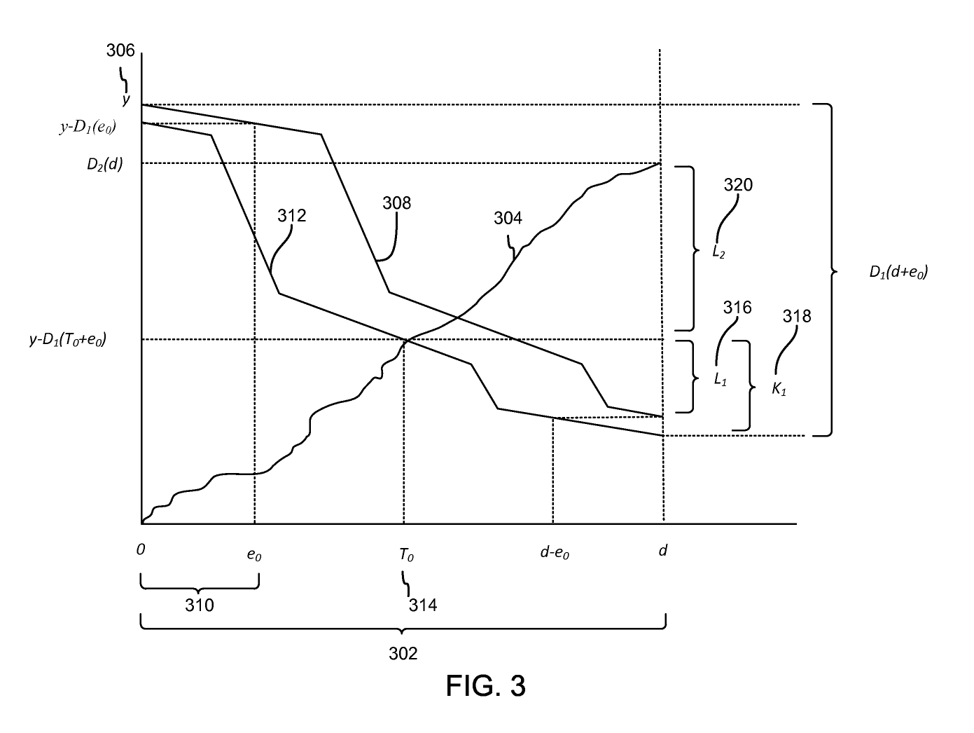

Because the two ordering channels may have different characteristics, storing items in the inventory 120 to support the two ordering channels may need to consider parameters associated with the respective characteristics. These parameters may relate the certainty and randomness of each of the two ordering channels. Example parameters are further described in FIG. 3. Additionally, because of the different characteristics, different implementations may be used to store the items in the inventory 120. Example implementations are further described in FIG. 2. Briefly, a first implementation may treat the subscription channel 130 and the regular channel 140 as two different and independent ordering channels. As such, a particular quantity of an item may be reserved in the inventory 120 for the subscription channel 130, while another quantity of the item may also be separately reserved in the inventory 120 for the regular channel 140. A second implementation may instead share the inventory 120 between the subscription channel 130 and the regular channel 140. In other words, a quantity of an item may not be reserved to any of the two ordering channels. Rather, a total quantity of the item in the inventory 120 may be shared and available for use in both of the two ordering channels.

Although the two implementations may support the two ordering channels, the second implementation may be more efficient. For example, computing efficiency and use of computing resources (e.g., processor device usage, memory usage, database usage for tracking and updating inventory) may be improved with the second implementation. In particular, the first implementation may use two inventory management systems hosted on different computing resources to support the two ordering channels and to keep the respective reserved quantities separate and independent of each other. In comparison, the second implementation may use one inventory management system, thereby reducing the use of computing resources. That may be because the inventory 120 may be shared between the two ordering channels. Other efficiency increases may also exist. Examples of such efficiencies are further illustrated in FIG. 2.

Turning to FIG. 2, the figure illustrates examples of the above two implementations that may be used to store units of an item in an inventory. In particular, a first implementation 210 may represent reserving inventories for each ordering channel. In the interest of clarity of explanation, this first implementation may be referred to herein as a “reserve implementation.” In comparison, a second implementation 240 may represent sharing an inventory between two ordering channels. In the interest of clarity of explanation, this second implementation may be referred to herein as a “share implementation.”

The reserve implementation 210 may treat a subscription channel 220 and a regular channel 230 as two separate and independent ordering channels, each having a respective inventory. As such, the subscription channel 220 may be supported by a reserved inventory 222, while the regular channel 230 may be supported by a different and independent reserved inventory 232. Accordingly, two or more inventory management systems, or instances of an inventory management system, may be used to generate plans for inventorying, tracking, and updating the respective reserved inventories 222 and 232. Further, customer subscriptions 224 to the subscriptions channels 220 may be treated independently of customer orders 234 of the regular channel 230. For example, the customer subscriptions 224 may be processed (e.g., by a corresponding inventory management system) to generate orders and, accordingly, provide reserved units 226 of items from the reserved inventory 222. Similarly, the customer orders 234 may be independently processed (e.g., by a corresponding inventory management system) to provide another set of reserved units 236 of items from the corresponding reserved inventory 232.

The two used inventory management systems may not share data about units of items stored in the respective reserved inventories 222 and 232. In other words, each inventory management system may generate a decision to store a quantity of units in the respective reserved inventory based on parameters specific to the corresponding ordering channel and independently of data associated with the other reserved inventory and/or parameters specific to the other ordering channel.

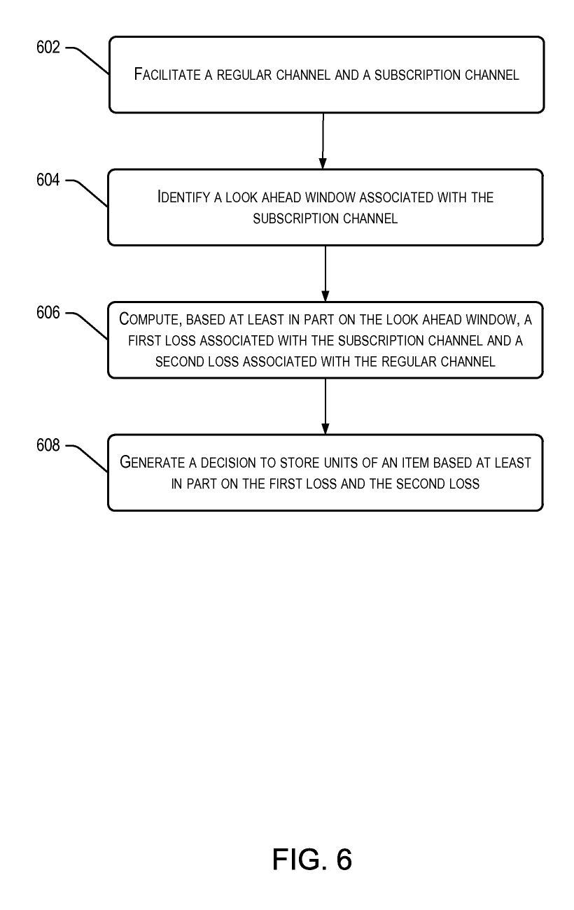

In comparison, the share implementation 240 may treat a subscription channel and a regular channel as two ordering channels that can be separate but that may share an inventory. Therefore, the share implementation 240 may account for dependencies associated with sharing the inventory. The dependencies may be based on the characteristics of each of the two ordering channels. For example, rather than reserving inventory to each ordering channel, the share implementation 240 may allow the inventory to be shared. For this sharing to be properly and efficiently managed, the share implementation 240 may account for the randomness of the regular channel and how this randomness may impact the subscription channel. This may include emphasizing or increasing a value of one parameter over another. For example, the share implementation 240 may consider that a loss from a canceled order associated with the subscription channel may have a higher impact than a loss from a canceled order associated with the regular channel. In another example, the share implementation 240 may consider a service level (e.g., a quality of service) associated with the subscription channel as having a higher value than other parameters. Examples of using the different parameters are further illustrated in FIGS. 6-9 and 11.

As illustrated in FIG. 2, the subscription channel and the regular channel (collectively shown as “subscription and regular channels 250”) of the share implementation 240 may be associated with a shared inventory 252. Accordingly, customer subscriptions 254 to the subscription channel and customer orders 256 received at the regular channel may be facilitated by a same inventory management system and supported from the shared inventory 252. In response to the subscriptions and orders, shared units 258 of items may be provided from the share inventory 252 to consumers. In this implementation, the inventory management system may consider the characteristics of each of the two ordering channels and the associated parameters to generate a decision for inventorying certain quantities of items to be shared between the two ordering channels, and to track and update the shared inventory 252. These and other features are further described in FIGS. 6-11.

Turning to characteristics and parameters associated with the ordering channels in more detail, the two ordering channels may differ in many ways. For example, the respective economic parameters, such as price and average shipping costs, may be different. The subscription demand in the short future may have little uncertainty, but may be highly non-constant, with strong day-of month effects. In contrast, regular demand may typically be highly uncertain. The out-of-stock behavior of the two ordering channels may also be different. Most importantly, because subscribed consumer may have received a promise (implicit or explicit) units of items may be shipped at regular intervals, there may implicitly be a very high cost associated with missing or canceling one or more of the shipments. Because of this, optimal decisions for storing units of the item in inventory may depend on the mix of the two ordering channels rather than on the aggregate of the two, and may typically provide a higher level of service for the subscription channel. However, because the two ordering channels may share inventory, providing a high level of service for the subscription demand may be challenging. For example, there can be inventory cannibalization between the two ordering channels (e.g., random orders received at the regular channels may deplete or reduce the shared inventory available to the subscription channel).

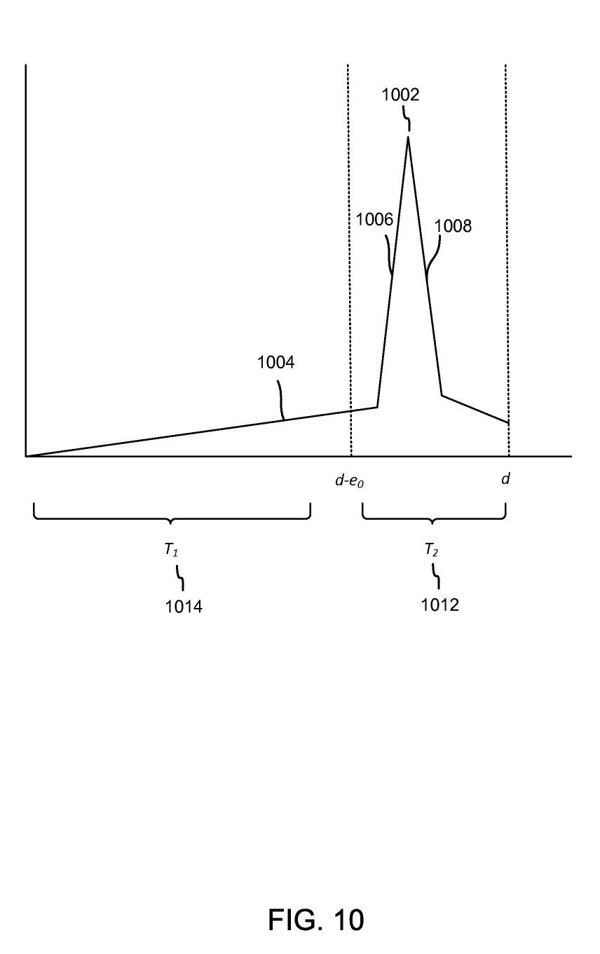

There may also be some important characteristics peculiar to the subscription channel that may need to be recognized in the share implementation 240. For example, there may be very little uncertainty about subscribed demand (or the automatically-generated orders based on subscriptions) over the short term (for example, the next four weeks). Cancellations may be the only source of uncertainty in the short term. Inventory can be earmarked (e.g., encumbered) and protected for shipments for a limited period of time (e.g., between a time when an order may be generated and a scheduled shipping date, such as five to eight days). In principle, unmet subscribed demand can be backordered (at least for short periods of time) in the event of stock-outs. For instance, sending a monthly shipment a couple of days late may be preferable to not sending the shipment at all. However, the shipment may most often be canceled if by the intended shipping date (or sometimes earlier) inventory may not have become available. Further, the subscribed demand may be peaky and, accordingly, may exhibit strong day-of-month effects (as shown in FIG. 10).

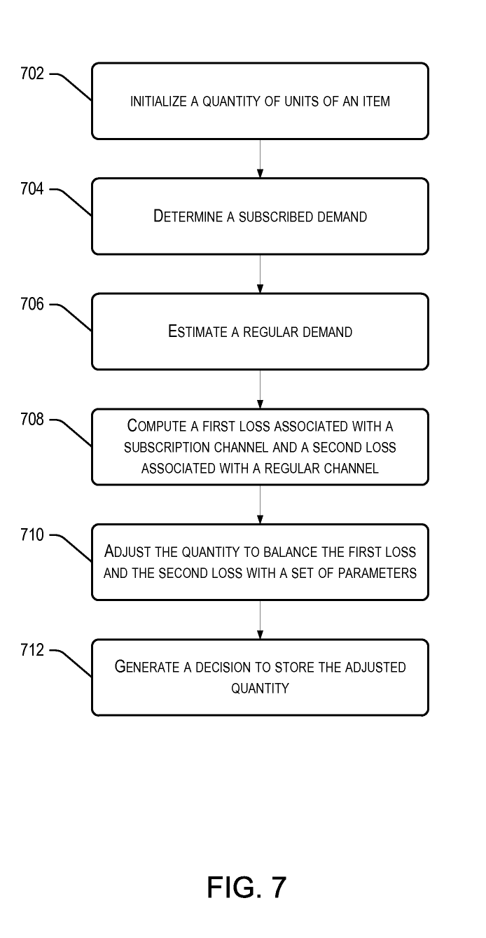

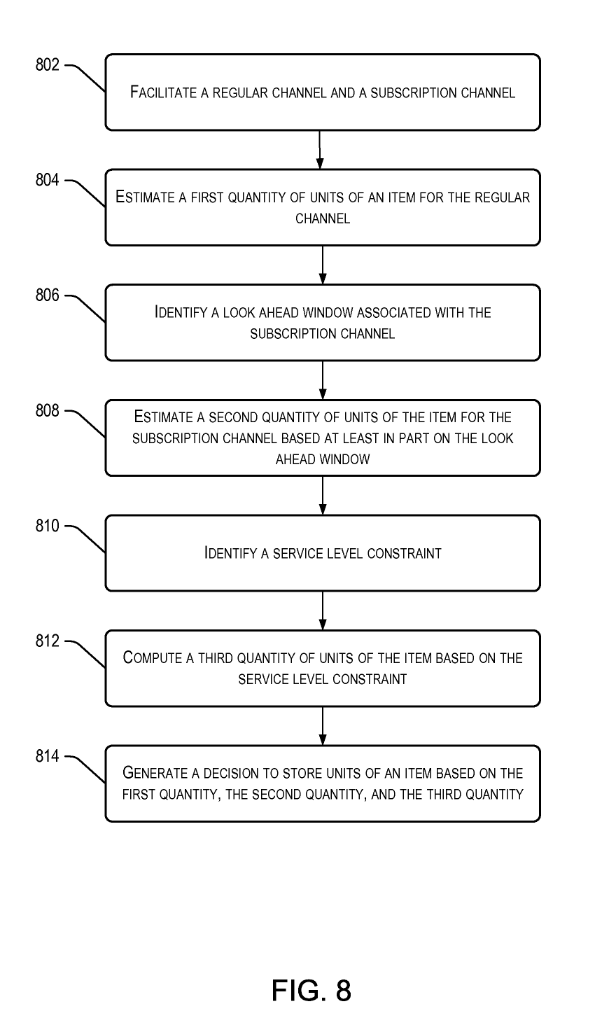

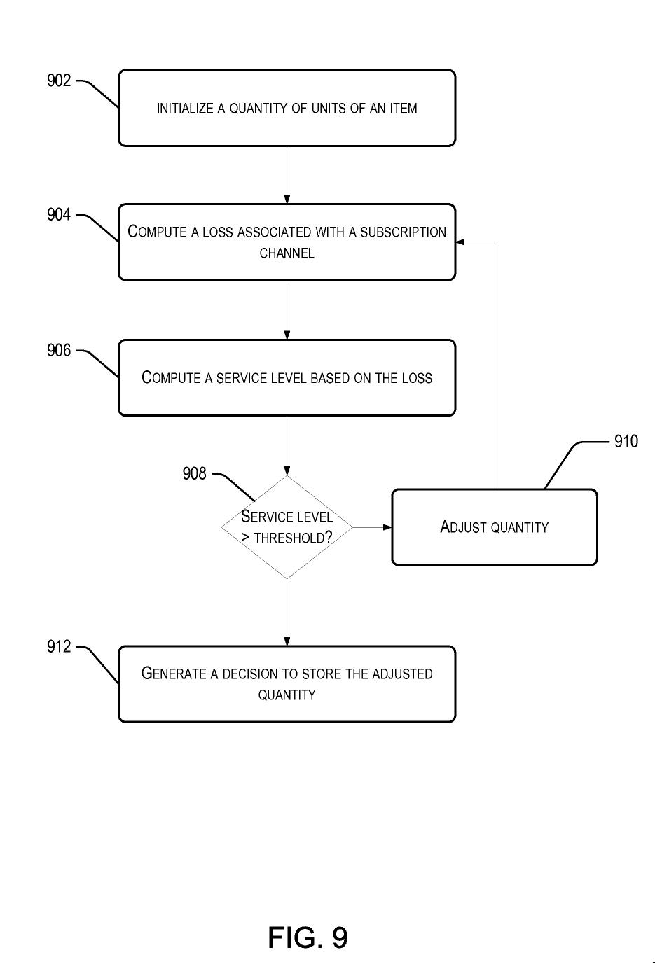

Because inventory may be shared between the two ordering channels as described in connection with the share implementation 240, there may be a risk that a larger than expected regular demand (e.g., regular random orders) may consume the inventory intended for the subscription channel. This may result in cancellation of subscribed shipments. As such, the inventory management system of the share implementation 240 may consider this risk to generate a decision associated with storing quantities of items in the shared inventory 252 during a planning horizon. There may be two approaches to consider this risk. A first approach is further illustrated in FIGS. 6 and 7. Briefly, this first approach may consider losses associated with canceled orders associated with the subscription channel (e.g., canceled subscribed shipments) and losses associated with lost random orders that may have been expected to be received during the planning horizon. These losses may represent costs of canceled subscribed shipments and lost sales. The first approach may balance at least one of the costs (e.g., the cost of canceled subscribed shipments or both costs) with other costs (e.g., a cost associated with carrying additional inventory). A second approach is further illustrated in FIGS. 8 and 9. Briefly, this second approach may treat a fraction (e.g., 99% or some other fraction) of on-time subscribed shipments as a hard quality of service constraint. In this second approach, the inventory management system may pad up an inventory with additional units to ensure that the risk of, for example, an unexpected surge in regular demand (e.g., random orders) may not result in canceling more than a certain number of subscribed shipments (e.g., 1%) to meet the quality of service constraint. In an embodiment, one of the two approaches may be used. In another embodiment, the two approaches may be used separately (the inventory system may implement the first approach for one category of items and the second approach to another category of items). In yet another embodiment, the two approaches may be used in conjunction (e.g., the inventory management system may implement the two approaches for a same category of items).

The above-two approaches of the share implementation 240 may use a common set of parameters. This set may include, for example, a look ahead window, a first loss (or cost) associated canceled subscribed shipments of the subscription channel, a second loss (or cost) associated with lost regular demand associated with the regular channel (e.g., a lost sale or random order that would have been expected to be received but that may no longer be possible because a corresponding item may have become out-of-stock), an expected regular demand, a determined subscription demand, a planning horizon, a stock-out time, and other channel-related parameters. Examples of these and other parameters are further illustrated in FIG. 3. Example usages of the parameters in each of the approaches are further illustrated in FIGS. 6-11.

Turning to FIG. 3, the figure illustrates parameters that an inventory management system of a share implementation may consider to generate a decision for storing units of items in an inventory shared between ordering channels of different types. In the interest of clarity of explanation, units of a same item are used in connection with describing the parameters. However, the embodiments are not limited to a single item, but may similarly apply a larger number of items. Generally, the inventory management system may generate a decision for storing units of an item in a shared inventory at recurring points in time. For example, every week (or some other time interval), a decision may be generated to store or replenish the shared inventory with a certain quantity of the units of the item. To illustrate, the decision generated on one Friday may be to add one hundred boxes of diapers, whereas a decision generated on a next Friday may be to add one hundred twenty five boxes of the diapers. Further, the decision may be associated with a planning horizon (e.g., ten days or some other time period). For example, the decision may be to store the certain quantity of the item in the shared inventory to support subscribed demand and expected regular demand during the planning horizon. Supporting the demands of the two ordering channels may include presenting an indication to consumers that the item may be available in-stock from the shared inventory. Continuing with the diapers illustration, the decision generated on one Friday may be to store the one hundred boxes of diapers to meet the two different demands in the next ten days starting on the next Monday.

Turning to the details of the various parameters illustrated in FIG. 3, an example parameter may include a planning horizon 302 (shown in FIG. 3 between points “0” and “d” on the horizontal axis). The planning horizon 302 may include, for example, a lead time and a storage time in the inventory for planned or projected use. The lead time may be variable and may include supplier-related lead time, shipping lead time related to receiving shipment from supplier(s), and other lead times. The storage time may be constant and may represent a period of time during which the stored units are expected to be used (e.g., shipped) to consumers in response to subscription orders and regular orders. As such, the planning horizon 302 may represent one dimension of uncertainty associated with the lead time variability. The inventory management system may generate or receive different realizations of the planning horizon 302 (e.g., expected planning horizons) with corresponding probabilities. These realizations and probabilities may be generated based on related historical data or input from a supplier(s).

Another parameter may also include expected regular demand 304 (abbreviated as D₂(d) in FIG. 3). The expected regular demand 304 may represent random orders expected to be received during the planning horizon 302 over a regular channel. Because these orders may be random, the expected regular demand 304 may be variable. As such, the expected regular demand 304 may be expressed as a function over time and may represent another dimension of uncertainty associated with the randomness of the regular channel. The inventory management system may generate or receive different realizations of the expected regular demand 304 with corresponding probabilities. In one example, each probability may correspond to one realization. In another example, each probability may correspond with a point on a realization. These realizations and probabilities may be generated based on related historical data.

Yet another parameter may include a total quantity 306 of the item to be inventoried during the planning horizon (abbreviated as “y” in FIG. 3, and may also be referred to as “up to order quantity TIP”). The inventory management system may be configured to output, as part of the generated decision, the total quantity 306 based on the other parameters. The total quantity 306 may represent the number of units of the item to be stored in the shared inventory to support the two ordering channels during the planning horizon. The smaller the total quantity 306 may be, the higher the risk that one ordering channel (e.g., the regular channel) may cannibalize the other ordering channel (e.g., the subscription channel). Conversely, the larger the total quantity 306 may be, the lower this risk may be but the higher the holding cost and other inventory-related costs may be. Thus, an optimum total quantity 306 may be computed based on balancing the different parameters as further described in FIGS. 6-11.

Another parameter may include a subscribed demand 308 (abbreviated as D₁ (d) and shown as a function of the total quantity 306 minus the expected regular demand 304 in FIG. 3). The subscribed demand 308 may represent deterministic orders associated with the subscription channel and may be expressed as a function over time. In particular, when a consumer subscribes to receiving units of the item by way of the subscription channel, the inventory management system, or another computing service, may generate a recurring and automatic order on behalf of the consumer. Typically, this order may be automatically generated just in time, such as at a point in time just sufficient to process and ship the item on time (the shipping time may be a selection in the subscription). For example, if the consumer subscribes to receiving the units every second Monday of the month, and two days may be needed to process and ship the item, the order may be automatically generated the Saturday before (e.g., two days ahead of the second Monday of the month). As such, multiple subscriptions from multiple consumers may correspond to the subscribed demand 308. In other words, this subscribed demand 308 may be deterministic and not variable and may be generated based on the consumer subscriptions received at the subscription channel.

Yet another parameter may include a look ahead window 310 (shown in FIG. 3 between points “0” and “e₀” on the horizontal axis). The look ahead window 310 may shift a time (e.g., move ahead by a certain time) associated with generating one or more automatic orders of a subscribed demand. In particular, because orders for the subscribed demand 308 may be automatically generated just in time and because the inventory may be shared between the two ordering channels, there could be a scenario where some of the automatic order could no longer be generated because the regular demand may have depleted the shared inventory. In other words, when it may be time to generate an automatic order and if no units of the item may be available from the shared inventory, the corresponding subscribed demand may be canceled resulting in a canceled subscribed shipment and a loss. One way to protect against this cannibalization from the regular channel may include using the look ahead window to shift the time for automatically generating the deterministic orders. As such, rather than generating automatic orders just in time, the automatic orders may be generated ahead of time as specified by the look ahead window (e.g., ten days rather than the two just in time days). The look ahead window 310 may provide the inventory management system with an advanced forecast or better visibility of automatic orders that should be supported during the planning horizon and, thus, reduce a likelihood of canceled automatic orders (e.g., canceled subscribed demand or subscribed shipment). The inventory management system, or another computing service, may compute a value of the look ahead window 310 using different approaches as further illustrated in FIGS. 6 and 7.

Another parameter may include a shifted subscribed demand 312 (shown as y-D₁(e₀) in FIG. 3). The shifted subscribed demand 312 may represent the subscribed demand 308 shifted by a value corresponding to the look ahead window 310. For example, by shifting the time(s) when automatic orders associated with the subscription channels may be generated based on the look ahead window 310, the shifted subscribed demand 312 may be generated. Accordingly, the shifted subscribed demand 312 may represent deterministic orders associated with the subscription channel and shifted based on the look ahead window 310 and may be expressed as a function over time.

Yet another parameter may include a stock-out time 314 (shown a T₀ in FIG. 3). The stock-out option may represent a point in time during the planning horizon when the item may become out-of-stock in the shared inventory. That point in time may depend on the planning horizon 302, the total quantity 306, the expected regular demand 304, and the shifted subscribed demand 312. As such, the stock-out time 314 may be variable and may be computed based on these other parameters and be associated with probabilities depending on the realizations of the expected regular demand 304 and the planning horizon 302. In an example, the stock-out time 314 may be computed based on the intersection of y-D₁(e₀) and D₂(d) as illustrated in FIG. 3.

Another parameter may include a loss 316 associated with canceled subscribed demand (shown as L₁ in FIG. 3). In particular, after the stock-out point 314, the item may have become out-of-stock. Accordingly, units of the item may no longer be available to support automatic orders occurring after the stock-out time 314 and the corresponding subscribed shipment. Accordingly, these orders may be canceled, resulting in the loss 316. In an example, the loss 316 may be computed based on the total quantity 306 and the shifted subscribed demand 312 or the subscribed demand 308. As such, the loss 316 may be variable and may depend on realizations and associated probabilities of the stock-out time 314. As illustrated in FIG. 3, the loss 316 may be computed as a function of y-D₁(T₀+e₀). Additionally, a cost corresponding to the loss 316 may be generated based on, for example, a unit cost, unit profit, unit holding cost, and the loss 316.

Yet another parameter may include a second loss 318 also associated with the canceled subscribed demand (shown as K₁ in FIG. 3). Similarly to the loss 316, this second loss 318 may be variable. In particular, the second loss 318 may represent a loss computed based in part on the shifted subscribed demand 312. However, because the look ahead window 310 may have been used, some of the automatic orders occurring after the stock-out time 314 (e.g., needing cancellation) may actually not represent a loss. More specifically, because of the time shifting and the additional time (rather than the just in time) used to generate these automatic orders, there may be sufficient time in the next planning horizon to generate automatic orders corresponding to the canceled ones from the current planning horizon. As such, although these orders may be canceled in the current planning horizon, these orders may nonetheless be captured in the next planning horizon, thereby avoiding an actual loss. The delta or difference between the second loss 318 and the loss 316 may represent this loss avoidance.

Another parameter may include another loss 320 associated with lost regular demand (shown as L₂ in FIG. 3). In particular, after the stock-out point 314, units of the item may no longer be available from the shared inventory. Accordingly, an indication that the item may be out-of-stock may be presented to consumers by way of the regular channel. Thus, after the stock-out point 314, consumer may no longer order units of item. This may result in the loss 320 because additional regular orders may have been expected for the remaining portion of the planning horizon 302. As such, the loss 320 may represent lost regular orders that may have been expected to be received at the regular channel during the planning horizon 302 (e.g., after the stock-out time 314). In an example, the loss 320 may be computed based on the total quantity 306, the expected regular demand 304, the stock-out time, and the shifted subscribed demand 312 or the subscribed demand 308. As such, the loss 320 may be variable and may depend on realizations and associated probabilities of expected regular demand 304 and the stock-out time 314.

The inventory management system may use the above parameters in different approaches to generate the decision for storing units of the item during the planning horizon 302. In an example, some or all of the parameters 302-320 may be provided to an objective function as variable parameters. The objective function may be configured to optimize a control parameter (e.g., to maximize profit or to meet a service level) using some or all of the variable parameters 302-320 and other parameters (e.g., holding cost). The different approaches are further illustrated in FIGS. 6-11. However, before describing these approaches, FIGS. 4 and 5 are described herein next. These figures describe an example computing environment for implementing a network-based resource, such as an electronic marketplace. The illustrated network-based resource may provide ordering channels of different types and sharing an inventory. To provide these ordering channels, the network-based resource may use an inventory management system that may implement the one or more of the various approaches and consider one or more of the parameters 302-320 and/or other parameters.

Turning to FIG. 4, the figure illustrates an example computing environment for providing a network-based resource configured to offer items to consumers. More particularly, a service provider 410 may provide an electronic marketplace 412 and manage an associated inventory 414 to facilitate offering items to consumers 440. Providing the electronic marketplace 412 may include providing a regular channel and a subscription channel. Managing the inventory may include using an inventory management system 416. The inventory management system 416 may be configured to generate decisions for storing units of items in the inventory 414, where the inventory 414 may be shared between the regular channel and the subscription channel. In an example, the inventory management system 416 may represent a computing resource or computing service independent of but interfacing with computing resources or computing services of the electronic marketplace 412. In another example, the inventory management system 416 may be integrated with one or more computing resources or computing services of the electronic marketplace 412.

The electronic marketplace 412 may include a plurality of computing resources configured to facilitate various services, such as offering items to the consumers 440 and to receiving offers from merchants 430. These services may also include providing the regular channel and the subscription channel. In addition, some of the offered items may be offered from the inventory 414. As such, a catalog of items available from the inventory 414 may be maintained. Indications of what items and associated quantities may be available from the inventory may be presented to the consumers 440 and the merchants 430. For example, network-based documents (e.g., web pages) may be used to present this information. More generally, the network-based documents may be configured to facilitate the interactions with the consumers 440 and the merchants 430. These documents may be hosted on the computing resources of the electronic marketplace 412. A network-based document may be associated with an item available from the inventory. For example, the network-based document may allow the merchants 430 and/or the service provider 410 to provide information for ordering the item. The network-based document may also allow the consumers 440 to review this information and make a purchase decision.

As such, the service provider 410 may operate the electronic marketplace 412 to facilitate interactions between the service provider 410, the merchants 430, and the consumers 440 over a network 450. Each one of the merchants 430 may operate one or more merchant computing devices 432A-N to access the electronic marketplace 412 and perform various merchant-related functions. For example, a merchant may update a description of an item, offer 434 a certain quantity of the item, provide lead-time related information, and perform other functions. Each one of the consumers 440 may operate one or more consumer computing devices 442A-M to access the electronic marketplace 412 and perform various consumer-related functions. For example, a consumer may subscribe 444 to receiving an item offered at the electronic marketplace 412 or order 446 an item available from the inventory 414.

Turning to FIG. 5, that figure illustrates an example end-to-end computing environment for offering items at an electronic marketplace. In this example, a service provider may configure the electronic marketplace to provide a regular channel and a subscription channel that may share an inventory. To efficiently share the inventory, the electronic marketplace may implement an inventory management service. This service may represent a computing service corresponding to the inventory management system described in connection with FIGS. 1-4.

In a basic configuration, a merchant 510 may utilize a merchant computing device 512 to access local applications, a web service application 520, a merchant account accessible through the web service application 520, a web site or any other network-based resources via one or more networks 580. In some aspects, the web service application 520, the web site, and/or the merchant account may be hosted, managed, and/or otherwise provided by one or more computing resources of the service provider, such as by utilizing one or more service provider computers 530. The merchant 510 may use the local applications and/or the web service application 520 to interact with the network-based resources of the service provider. The interaction may include, for example, monitoring offering items for sale, updating descriptions and offers of items, providing lead-time related information, and merchant-related interactions.

In some examples, the merchant computing device 512 may be any type of computing devices such as, but not limited to, a mobile phone, a smart phone, a personal digital assistant (PDA), a laptop computer, a thin-client device, a tablet PC, etc. In one illustrative configuration, the merchant computing device 512 may contain communications connection(s) that allow the merchant computing device 512 to communicate with a stored database, another computing device or server, merchant terminals, and/or other devices on the networks 580. The merchant computing device 512 may also include input/output (I/O) device(s) and/or ports, such as for enabling connection with a keyboard, a mouse, a pen, a voice input device, a touch input device, a display, speakers, a printer, etc.

The merchant computing device 512 may also include at least one or more processing units (or processor device(s)) 514 and one memory 516. The processor device(s) 514 may be implemented as appropriate in hardware, computer-executable instructions, firmware, or combinations thereof. Computer-executable instructions or firmware implementations of the processor device(s) 514 may include computer-executable or machine-executable instructions written in any suitable programming language to perform the various functions described.

The memory 516 may store program instructions that are loadable and executable on the processor device(s) 515, as well as data generated during the execution of these programs. Depending on the configuration and type of merchant computing device 512, the memory 516 may be volatile (such as random access memory (RAM)) and/or non-volatile (such as read-only memory (ROM), flash memory, etc.). The merchant computing device 512 may also include additional storage, which may include removable storage and/or non-removable storage. The additional storage may include, but is not limited to, magnetic storage, optical disks, and/or tape storage. The disk drives and their associated computer-readable media may provide non-volatile storage of computer-readable instructions, data structures, program modules, and other data for the computing devices. In some implementations, the memory 516 may include multiple different types of memory, such as static random access memory (SRAM), dynamic random access memory (DRAM), or ROM.

Turning to the contents of the memory 516 in more detail, the memory may include an operating system (O/S) 518 and the one or more application programs or services for implementing the features disclosed herein including the web service application 520. In some examples, the merchant computing device 512 may be in communication with the service provider computers 530 via the networks 580, or via other network connections. The networks 580 may include any one or a combination of many different types of networks, such as cable networks, the Internet, wireless networks, cellular networks, and other private and/or public networks. While the illustrated example represents the merchant 510 accessing the web service application 520 over the networks 580, the described techniques may equally apply in instances where the merchant 510 interacts with the service provider computers 530 via the merchant computing device 512 over a landline phone, via a kiosk, or in any other manner. It is also noted that the described techniques may apply in other client/server arrangements (e.g., set-top boxes, etc.), as well as in non-client/server arrangements (e.g., locally stored applications, peer-to-peer systems, etc.).

Similarly, a consumer 560 may utilize consumer computing device 562 to access local applications, a web service application 570, a consumer account accessible through the web service application 570, a web site, or any other network-based resources via the networks 580. In some aspects, the web service application 570, the web site, and/or the user account may be hosted, managed, and/or otherwise provided by the service provider computers 530 and may be similar to the web service application 520, the web site accessed by the computing device 512, and/or the merchant account, respectively.

The consumer 560 may use the local applications and/or the web service application 570 to conduct transactions with the network-based resources of the service provider. These interactions may include, for example, searching for items, requesting, ordering, and obtaining items using a regular channel and/or a subscription channel, and other consumer-related interactions.

In some examples, the consumer computing device 562 may be configured similarly to the merchant computing device 512 and may include at least one or more processing units (or processor device(s)) 564 and one memory 566. The processor device(s) 564 may be implemented as appropriate in hardware, computer-executable instructions, firmware, or combinations thereof similarly to the processor device(s) 515. Likewise, the memory 566 may also be configured similarly to the memory 516 and may store program instructions that are loadable and executable on the processor device(s) 564, as well as data generated during the execution of these programs. For example, the memory 566 may include an operating system (O/S) 568 and the one or more application programs or services for implementing the features disclosed herein including the web service application 570.

As described briefly above, the web service applications 520 and 570 may allow the merchant 510 and consumer 560, respectively, to interact with the service provider computers 530 to conduct transactions involving items. The service provider computers 530, perhaps arranged in a cluster of servers or as a server farm, may host the web service applications 520 and 570. These servers may be configured to host a web site (or combination of web sites) viewable via the computing devices 512 and 562. Other server architectures may also be used to host the web service applications 520 and 570. The web service applications 520 and 570 may be capable of handling requests from many merchants 510 and consumers 560, respectively, and serving, in response, various interfaces that can be rendered at the computing devices 512 and 562 such as, but not limited to, a web site. The web service applications 520 and 570 can interact with any type of web site that supports interaction, including social networking sites, electronic retailers, informational sites, blog sites, search engine sites, news and entertainment sites, and so forth. As discussed above, the described techniques can similarly be implemented outside of the web service applications 520 and 570, such as with other applications running on the computing devices 512 and 562, respectively.

The service provider computers 530 may, in some examples, provide network-based resources such as, but not limited to, applications for purchase and/or download, web sites, web hosting, client entities, data storage, data access, management, virtualization, etc. The service provider computers 530 may also be operable to provide web hosting, computer application development, and/or implementation platforms, or combinations of the foregoing to the merchant 510 and consumer 560.

The service provider computers 530 may be any type of computing device such as, but not limited to, a mobile phone, a smart phone, a personal digital assistant (PDA), a laptop computer, a desktop computer, a server computer, a thin-client device, a tablet PC, etc. The service provider computers 530 may also contain communications connection(s) that allow service provider computers 530 to communicate with a stored database, other computing devices or servers, merchant terminals, and/or other devices on the network 580. The service provider computers 530 may also include input/output (I/O) device(s) and/or ports, such as for enabling connection with a keyboard, a mouse, a pen, a voice input device, a touch input device, a display, speakers, a printer, etc.

Additionally, in some embodiments, the service provider computers 530 may be executed by one more virtual machines implemented in a hosted computing environment. The hosted computing environment may include one or more rapidly provisioned and released network-based resources. Such network-based resources may include computing, networking, and/or storage devices. A hosted computing environment may also be referred to as a cloud computing environment. In some examples, the service provider computers 530 may be in communication with the computing devices 512 and 562 via the networks 580, or via other network connections. The service provider computers 530 may include one or more servers, perhaps arranged in a cluster, or as individual servers not associated with one another.

In one illustrative configuration, the service provider computers 530 may include at least one or more processing units (or processor devices(s)) 532 and one memory 534. The processor device(s) 532 may be implemented as appropriate in hardware, computer-executable instructions, firmware, or combinations thereof. Computer-executable instruction or firmware implementations of the processor device(s) 532 may include computer-executable or machine-executable instructions written in any suitable programming language to perform the various functions described.

The memory 534 may store program instructions that are loadable and executable on the processor device(s) 532, as well as data generated during the execution of these programs. Depending on the configuration and type of the service provider computers 530, the memory 534 may be volatile (such as random access memory (RAM)) and/or non-volatile (such as read-only memory (ROM), flash memory, etc.). The service provider computers 530 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 534 may include multiple different types of memory, such as static random access memory (SRAM), dynamic random access memory (DRAM), or ROM.

Additionally, the computer storage media described herein may include computer-readable communication media such as computer-readable instructions, program modules, or other data transmitted within a data signal, such as a carrier wave, or other transmission. Such a transmitted signal may take any of a variety of forms including, but not limited to, electromagnetic, optical, or any combination thereof. However, as used herein, computer-readable media does not include computer-readable communication media.

Turning to the contents of the memory 534 in more detail, the memory may include an operating system (O/S) 536, code for an electronic marketplace 538, data related to an inventory catalog 540 associated with the electronic marketplace 538, and code for an inventory management service 542. The inventory catalog 540 may represent a structure for storing data about what items and associated quantities may be available from an inventory associated with the electronic marketplace 538. The inventory management service 542 may represent a computing service implementing some or all of the functionalities of the inventory management system described in connection with FIGS. 1-4. Although FIG. 5 illustrates the various data as stored in the memory 534, this data or portion of the data may be additionally or alternatively stored at a storage device remotely accessible to the service provider computers 530. Configurations and operations of the inventory management service 542 and interactions with the electronic marketplace 538, consumer computing devices 562 and merchant computing devices are further described in greater detail below with reference to at least FIGS. 6-11.

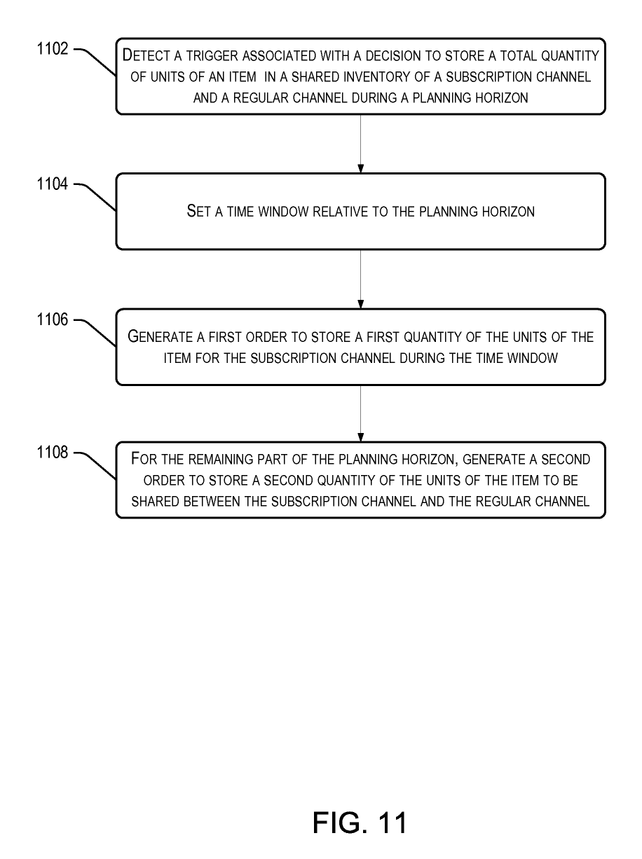

FIGS. 6-9 and 11 illustrate example flows for generating a decision to store units of an item in an inventory shared between ordering channels of different types. Generally, different parameters, such as the ones described in connection with FIG. 3 and other parameters, may be analyzed to generate the decision. More particularly, FIGS. 6 and 7 illustrate using loss and revenue parameters, while FIGS. 8 and 9 illustrate using loss and quality parameters. By sharing the inventory, and by using the different parameters, a service level associated with the one channel (e.g., a subscription channel) may be induced without reducing a quality of service associated with the other channel (e.g., a regular channel). Further, FIG. 11 further illustrates an example flow for generating a decision that may split a total quantity of units into two quantities. This decision may be generated on loss, revenue, and/or quality parameters. The first quantity of the decision may be shared between the ordering channels, whereas the second quantity may be encumbered for one of the ordering channels.

In the interest of clarity of explanation, the example flows are described in the context of a decision associated with an item and in the context of a subscription channel and a regular channel. Nevertheless, the example flows may not be limited as such. Instead, the example flows may similarly apply to a larger number of items, any grouping of items, and/or one or more categories of items. The example flows may also similarly apply to any number of ordering channels of different types. There may also be similarities between the operations of the different example flows. In the interest of clarity of explanation, such similarities may not be repeated.

Further, each of the operations or functions of the example flows may be embodied in, and fully or partially automated by, modules executed by one or more processor devices of a computing device. Although an inventory management system (e.g., an inventory management service executed on a service provider computer) is illustrated as performing operations of the example flows, other or a combination of other computing services, modules, and systems may be additionally or alternatively used. Also, while the operations are illustrated in a particular order, it should be understood that no particular order is necessary and that one or more operations may be omitted, skipped, and/or reordered.

Turning to FIG. 6, the figure illustrates an example flow for generating a decision to acquire units of an item for storage in an inventory shared between a subscription channel and a regular channel. The decision may be based on balancing loss parameters associated with these two ordering channels with other parameters, such as holding cost and revenue. In an example, the loss parameters may be used in an objective function as variable parameters. The objective function may be configured to optimize a control parameter, such as to maximize revenue, based on a number of variable parameters. These and other features are further described herein next.

The example flow of FIG. 6 may start at operation 602, where a regular channel and a subscription channel may be facilitated. For example, computing resources of a network-based resource, such as an electronic marketplace, may be configured to provide the regular channel and the subscription channel. These two ordering channels may allow computing devices of users to access offers related to the item, where the offers could be of different types. On one hand, the regular channel may allow a user, such as a consumer, to place a one-time order of units of the item based on an offer. On the other hand, the subscription channel may allow a user, such as a consumer, to place a one-time subscription to receiving units of the item at recurring times. In association with the network-based resource, an inventory management system may manage an inventory of the item shared between the two ordering channels. The management of the shared inventory may be provided as part of facilitating the two ordering channels. For example, the inventory management system may be configured to generate the decision to acquire units of the item and track and update an availability of the item from the inventory, thereby allowing units of the item to be offered as available or not from the inventory.

At operation 604, a look ahead window associated with the subscription channel may be identified. For example, the inventory management system may access, receive, or compute a value of the look ahead window. The value may specify or shift a time for generating automatic orders on behalf of subscribed consumers (e.g., deterministic orders associated with the subscription channel). In particular, the decision of the inventory management system may be associated with two time-related parameters: a planning horizon and a particular point in time for generating the decision. In an example, the value of the look ahead window may move the time for generating the automatic orders ahead of the particular time for generating the decision. This time shift may provide the inventory management system an advanced forecast of the subscribed demand during the planning horizon.

The value of the look ahead window may be identified using one or a combination of different approaches. In an example, the value may be derived from empirical experimentation. In another example, the value may be set as a function of the planning horizon (e.g., at least as long as the planning horizon). In yet another example, an iterative process may be used to identify a value that maximizes a parameter, such as revenue or profit. For instance, the value may be set to a first time (e.g., five days), losses associated with the two ordering channels may be estimated, and a profit based on these two losses may be determined. Iteratively, the value may be set to another time (e.g., ten days), the losses re-estimated, and the profit accordingly determined and compared to the profit associated with the first time. The process may be repeated until finding a particular time that may maximize the profit. The value of the look ahead window may be at least equal to that particular time.

At operation 606, a first loss associated with the subscription channel and a second loss associated with the regular channel may be computed. The first loss may represent a canceled subscribed shipment (e.g., a loss associated with losing a deterministic order during the planning horizon). The second loss may represent a loss associated with a lost order (e.g., a loss associated with losing a random order that may have been expected to be received during the planning horizon). For example, the inventory management system may access, receive, or generate a forecast of a subscribed demand (e.g., an amount of the deterministic orders associated with the subscription channel) during the planning horizon based on the look ahead window (e.g., based on generating the deterministic orders ahead of time). Similarly, the inventory management system may access, receive, or generate an estimate of regular demand (e.g., an amount of random orders associated with the regular channel) expected to be received during the planning horizon. The inventory management system may also initialize a total quantity of the units of the item to an initial quantity. For instance, the initial quantity may be set to be at least equal to, a multiplier of, or some other function of the sum of the subscribed demand and regular demand (e.g., the sum of the amount of deterministic orders and the amount of random orders). Based on the subscribed demand, the regular demand, and the initial quantity, a stock-out point in time may be determined. That point in time may be used to compute the first loss and the second loss as functions of unfulfilled subscribed demand and regular demand, respectively, because the item may be stocked out (e.g., no units of the item may remain available in the inventory after the stock-out point in time for the remainder of the planning horizon).

At operation 608, a decision to store units of the item may be generated based at least in part on the first loss and the second loss. This decision may include deciding on the total quantity of the item to acquire and store in the shared inventory to support the regular channel and the subscription channel during the planning horizon. As explained herein above, the decision may be generated at particular point in time (e.g., a time after the deterministic orders of the subscription channels may have been generated).

In an example, the inventory management system may balance the first loss and the second loss against another set of parameters, such as holding cost and revenue (or profit). The holding cost may represent a cost for storing the total quantity of the item in the shared inventory during the planning horizon. The revenue may represent income of selling units of the item at the two ordering channels during the planning horizon. For example, the inventory management system may compare the first loss and the second loss to the holding cost to determine an impact to the revenue. As long as the two losses may be smaller than the holding cost, the revenue may be positively impacted. Based on the comparison, the inventory management system may adjust the total quantity, re-compute the first and second loss, and balance the re-computed losses against the holding cost until a condition associated with the revenue may be met (e.g., until the revenue may be maximized or until the revenue may be negatively impacted). As such, adjusting the total quantity may include an iterative process that may repeat operations 606 and 608 until the condition may be met. In an example, the iterative process may include providing the first loss and the second loss as variable parameters to an objective function. The objective function may be configured to optimize a control parameter, such as the revenue, based on a set of variable parameters. In addition to the first loss and the second loss, the set of variable parameters may include the holding cost, the total quantity, and other parameters. An example of an objective function and the associated parameters is further illustrated in connection with FIG. 7.

Turning to FIG. 7, the figure illustrates a more detailed example flow for generating the decision to store the units of the item based on the first loss and the second loss. In particular, operations of the example flow of FIG. 7 may further embody operations of the example flow of FIG. 6. Thus, some operations may be similar. Such similarities may not be repeated herein in the interest of clarity of explanation.

As described herein above, a subscribed demand generated based on a look ahead window may be deterministic. In comparison, a regular demand, a planning horizon, a stock-out point in time, and a total quantity may be variable. This variability may result in different estimations of the first loss and the second loss. Accordingly, to generate the decision, the inventory management system may consider not only the subscribed demand based on the look ahead window, but also the variability of the other parameters. These and other features are further described herein below.

The example flow of FIG. 7 may start at operation 702, where a quantity of units of an item may be initialized. This quantity may represent a total quantity that should be stored during a planning horizon in an inventory shared between a subscription channel and a regular channel. In an example, an inventory management system may set the quantity as a function of a subscribed and regular demand (e.g., to be at least equal to, a multiplier of, or some other function of the sum of the two demands). In another example, the inventory management system may set the quantity to a latest quantity of the units of the item currently available from the shared inventory.

At operation 704, a subscribed demand may be determined. For example, a look ahead window may have been used to generate the subscribed demand during a planning horizon on behalf of subscribed consumers (e.g., deterministic orders automatically generated based on subscriptions of the consumers). Accordingly, the inventory management system may determine and express, as a function of time, an amount of the subscribed demand (e.g., a count of the deterministic orders) that may occur during the planning horizon.

At operation, 706, a regular demand may be estimated. The regular demand may represent random orders expected to be received during the planning horizon. For example, the inventory management system may compute, or some other computing system may compute and provide to the inventory management system, an estimate of the regular demand. The estimate may be based on historical data associated with past or historical random orders received at the regular channel and may be expressed as a function of time.

In an example, the regular demand may be variable. Further, estimating the regular demand may include estimating other variable parameters that may be associated with, related to, or impacted by the variability of the regular demand. These other parameters may include, for example, the planning horizon. The planning horizon may be variable because of, for instance, lead times (e.g., supplier or merchant lead times). As such and in this example, estimating the regular demand may include generating different realizations of the regular demand and realizations of the planning horizon and computing likelihoods of the realizations based on, for instance, the historical data associated with the regular demand and the supplier lead times.

At operation 708, a first loss associated with the subscription channel (e.g., a loss from losing a deterministic order) and a second loss associated with the regular channel (e.g., a loss from losing an expected random order) may be computed. For example, the inventory management system may compute the first loss and the second loss based on the quantity of the units of the item, the subscribed demand, the regular demand, and the planning horizon. In particular, a stock-out point in time may be derived from the quantity of the units of the item, the subscribed demand, and the regular demand. Accordingly, the first loss may be computed from remaining unfulfilled subscribed demand occurring after the stock-out point in time until the end of the planning horizon. Similarly, the second loss may be computed from remaining regular demand expected to be received between the stock-out pint in time and the end of the planning horizon. Because the regular demand and the planning horizon may be variable, the stock-out point in time may also be variable. As such, computing the two losses may account for the realizations of the regular demand and planning horizon and the associated likelihoods. Various computing approaches may be used to account for the realizations and the likelihoods. One approach may include a top down process that may consider the complete regular and subscribed demand, while another approach may include a bottom up process that may consider individual orders as further described herein next.

In a top down process, for each realization i of the regular demand (dⁱ) and of the planning horizon (PHⁱ) and an associated likelihood (pⁱ), a potential first loss (L₁ⁱ) may be computed. This potential first loss (L₁ⁱ) may be expressed as a function of the other two realizations and the likelihood, such as (L₁ⁱ:f(dⁱ, PHⁱ)×pⁱ). The first loss (L₁) may then be computed as a sum of (L₁ⁱ) over all realizations (or a set of realizations), such as (L₁=Σᵢ L₁ⁱ). The second loss (L₂) may be similarly computed, where (L₁=Σᵢ L₂ⁱ) and (L₂ⁱ:f(dⁱ, PH^{k})×pⁱ).

In a bottom up process, for each deterministic order k of the subscribed demand, a likelihood (p^{k}) of that deterministic order k being canceled may be computed based on all realizations (or a set of realizations) i of the regular demand (dⁱ) and of the planning horizon (PHⁱ) and associated likelihoods (pⁱ), such as (p^{k}:Σᵢ pⁱ, [dⁱ, PHⁱ]). Thereafter, a cancellation likelihood (P₁) may be computed by integrating the likelihood (p^{k}) over the entire subscribed demand (e.g., with similarly-computed likelihoods (p^{k}) of other deterministic orders placed during the planning horizon), such as (P₁=∫p^{k}) over the subscribed demand. The first loss may be computed based on this cancellation likelihood (e.g., as a function of per unit profit and the cancellation likelihood). The second loss may similarly be computed. For example, for each random order l expected to be received, likelihood (p^{l}) of that random order l being lost may be computed based on all realizations (or a set of realizations) i of the regular demand (dⁱ) and of the planning horizon (PHⁱ) and associated likelihoods (pⁱ), such as (p^{l}:Σᵢ pⁱ, [dⁱ, PHⁱ]). Thereafter, a loss likelihood (P₂) may be computed by integrating the likelihood (p^{l}) over the entire regular demand (e.g., with similarly-computed likelihoods (p^{l}) of other random orders expected during the planning horizon), such as P₂=∫p^{l} over the regular demand. Thereafter, the second loss may be computed based on this cancellation likelihood.

At operation 710, the quantity of the units of the item may be adjusted to balance the first loss and the second loss with a set of parameters. This set may include holding cost, revenue (or profit), and other parameters. For example, the inventory management system may increase or decrease the quantity such that a sum of the two losses may not exceed the holding cost, thereby avoiding a negative impact to the revenue. This may include iteratively repeating operations 702-708 until, for example, determining a quantity associated with minimum first and second losses that may minimize the holding cost and/or maximize the revenue. In an embodiment, the inventory management system may implement an objective function that may optimize a control parameter (e.g., profit) based on a set of variable parameters (e.g., the first loss, the second loss, the holding cost, and other parameters). An example objective function is further described herein below.

At operation 712, a decision to store the adjusted quantity may be generated. For example, the inventory management system may generate the decision by specifying the quantity and the planning horizon and issuing corresponding orders to a supplier(s) and/or a merchant(s).

An illustrative objective function is described herein next. In particular, the following notations may be used:
D₁(t)=subscribed demand with shipping date in the time interval (0, t]. Assumed to be deterministic.
D₂(t)=regular demand over (0, t].
e₀=look ahead window. Subscribed order is “encumbered” (automatically generated) e₀ days before its intended shipping date, or when first available thereafter.
\tilde{D}₁(t)=subscribed demand with encumbrance date in the interval (0, t]; D₁ and \tilde{D}₁ may be the same curve shifted by e₀:\tilde{D}₁(t)=D₁(t+e₀); D₁(t)=\tilde{D}₁(t−e₀).
L₂(t)=lost regular demand over (0, T].
L₁(t)=missed subscribed shipments over (0, T].
K₁(t)=subscribed orders that could not be encumbered when first attempted over (0, t] (may include canceled orders and others that may have been encumbered late but shipped on time).
λ₂=consumer in stock value (CIV) for regular demand. CIV may represent a value associated with a long term benefit resulting from showing the item at a network-based resource as available in stock. An example of CIV is further described in U.S. patent application Ser. No. 14/318,227 filed on Jun. 27, 2014, entitled “Determining the Value of an Item,” which is incorporated herein by reference in its entirety.
λ₁=Cost of canceled subscribed order.
cshipⱼ=Shipping cost for channel j.
pⱼ=Selling price (+ adjustments) for channel j.
c=vendor cost (+ adjustments: ACC receipt penalties, receipt cost, vendor refunds, etc.). Same for both channels.
θ=holding and storage cost for units remaining in inventory at the end of the planning horizon.
b₁=buy date i (e.g., particular point in time to generate a decision). Up to quantity (TIP) may be computed for buy date b₁=0, and b₂>0, may be the next buy date.
Wᵢ=lead time associated with the second buy date i. Wᵢ may be assumed to take the values in (ωᵢⱼ) with the probabilities in (gᵢⱼ), such as P (W₁=ωᵢⱼ)=gᵢⱼ.
G̅ᵢ(t)=P (Wᵢ>t)=Σ_{{j:w}_{ᵢⱼ}_{>t}}gᵢⱼ
F̅₂(⋅; t) may be the complementary cumulative distribution function (ccdf) of the regular demand over (0, t], i.e., F̅₂(u; t)=P(D₂(t)>u).
T₂=b₂+W₂=end of planning horizon=arrival time of next purchase order (after the one being decided on now).
When t=T₂ the time dependency in D₁(t) may be implemented, and D₁(t) may be simply written as D₁. \tilde{D}₁, D₂, L₁, L₂, K₁ may be similarly written.
D₁(t₁,t₂) may represent D₁(t₂)−D₁(t₁). Similar representations may be used for \tilde{D}₁, D₂, L₁, L₂, K₁.

The following first assumption may be made:
(i) Subscribed demand over the planning horizon D₁(⋅) is known in advance and hence treated as deterministic.
(ii) In the event of a stock-out, unmet regular demand may be lost.
(iii) In the event of a stock-out, subscribed orders may be canceled on the respective ship dates, as these orders become due, unless inventory had been encumbered for these orders before the stock-out.
(iv) Inbound supply may be first allocated to subscribed orders with shipping dates that may be in the upcoming e₀ days and that may not have yet encumbered inventory (presumably tried and failed, and showing as unfilled demand). The remaining (if any) may be made free to serve regular demand and subscribed demand with shipping dates further into the future.
(v) No order crossing may be assumed, so that b₁+W₁≤b₂+W₂.
(vi) Lead times may be assumed to be independent of demand.

With regard to point (iii), methods herein can also be applied under the alternative assumption that subscribed demand can be backordered.

Continuous time models may be used. However, discrete time settings may be alternatively or additionally used. To use discrete time setting, the following assumption may be made: inventory for subscribed demand may be encumbered at the end of each day, for the next e₀ days. The subscribed demand to be shipped on day k, that may be over the interval (k−1, k), may be encumbered at time k−e₀, the end of the (k−e₀)-th day. An alternative assumption of the encumbrance happening at the start of each day may be equivalent but with encumbrance period e₀+1 instead of e₀.

To write an objective function configured to maximize profit (or revenue), it may be important to recognize that lost regular demand and missed subscribed shipments may not depend only on the total demands for these ordering channels over the planning horizon, but rather on the whole cumulative demand curves for these ordering channels (as illustrated in FIG. 2). An important takeaway may include the following identity: (D₂+\tilde{D}₁−TIP)⁺=K₁+L₂.

Using this fact, the objective function (EOM_OF(TIP)) may be expressed as following,

$$EOM\_OF ( TIP ) = ( {p}_{2} + {λ}_{2} - {cship}_{2} ) \overbrace{\{ E {D}_{2} - {E ( {D}_{2} + {\tilde{D}}_{1} - TIP )}^{+} + E {K}_{1} \}}^{E {D}_{2} - {EL}_{2}} + ( {p}_{1} - {cship}_{1} ) \{ {ED}_{1} - {EL}_{1} \} - {λ}_{1} {EL}_{1} - cTIP - θ {E ( TIP - {D}_{1} - {D}_{2} )}^{+} + ENPV ( {( TIP - {D}_{1} - {D}_{2} )}^{+} ) .$$

The first term may correspond to revenue for regular sales over the planning horizon; the second term may correspond to revenue generated by on-time subscribed shipments over the planning horizon; the third term may represent the cost of missed subscribed shipments over the planning horizon; the fourth term may represent the procurement cost; the fifth term may represent the holding and storage cost; and the last term may represent the residual value of any units left in inventory at the end of the planning horizon, as given by a net present value (NPV) curve.

By reordering,

EOM_OF(TIP)=(p₂+λ₂−cship₂){ED₂−E(D₂+D₁−TIP)⁺}−c(TIP−ED₁)

θE(TIP−D₁−D₂)⁺+ENPV((TIP−D₁−D₂)⁺)

+(p₁−cship₁−c)ED₁

+(p₂+λ₂−cship₂){E(D₂−TIP+D₁)⁺−E(D₂−TIP+\tilde{D}₁)⁺}

+{−p₁+cship₁−λ₁}EL₁+(p₂+λ₂−cship₂)EK₁ (1)

By conditioning on lead time realizations and using the fact that D1(t) may be deterministic (for given t),

$$EOM\_OF ( TIP ) = {\sum }_{j} g {2}_{j} \{ ( {p}_{2} + {λ}_{2} - {cship}_{2} ) Emin ( {D}_{2} , TIP - {D}_{1} ( {b}_{2} + ω {2}_{j} ) ) - c ( TIP - {D}_{1} ( {b}_{2} + w {2}_{j} ) ) - θ {E ( TIP - {D}_{1} ( {b}_{2} + {w}_{2 j} ) - {D}_{2} )}^{+} + ENPV ( ( TIP - {D}_{1} ( {b}_{2} + {w}_{{2}_{j}} ) - {D}_{2} ) + ) \} + ( {p}_{1} - {cship}_{1} - c ) {\sum }_{j} {g}_{2 j} {D}_{1} ( {b}_{2} + {w}_{{2}_{j}} ) + ( {p}_{2} + {λ}_{2} - {cship}_{2} ) {\sum }_{j} {g}_{2 j} \{ {E ( {D}_{2} - TIP + {D}_{1} ( {b}_{2} + w {2}_{j} ) )}^{+} - {E ( {D}_{2} - TIP + {\tilde{D}}_{1} ( {b}_{2} + {w}_{{2}_{j}} ) )}^{+} \} + \{ - {p}_{1} + {cship}_{1} - {λ}_{1} \} {EL}_{1} + ( {p}_{2} + {λ}_{2} - {cship}_{2} ) {EK}_{1} .$$

The first term on the right hand may almost be exactly the same as an objective function restricted to the regular demand. One or the only difference may be that the order to quantity (TIP) may be replaced by (TIP−D₁(b₂+w₂ⱼ)). Hence, this number may be different for each planning horizon scenario within the sum.

The last two terms on the right hand side may need the computation of EL₁ and EK₁ as a function of the order up to quantity (TIP). As further shown below, if the TIP=y and d may be the longest possible planning horizon, d=sup{t≥b₁:P(b₂+W₂≥t)>0}, then

$${EK}_{1} = {\sum }_{t - 1}^{d} {\overline{G}}_{2} ( t - {b}_{2} ) {\int }_{u = y - {\tilde{D}}_{1} ( t )}^{y - {\tilde{D}}_{1} ( t - 1 )} {\overline{F}}_{2} ( u ; t ) du . \\ and$$

$${EL}_{1} == {\sum }_{t = {e}_{0} + 1}^{{d}_{M}} {\overline{G}}_{2} ( t - {b}_{2} ) {\int }_{u = y - {D}_{1} ( t )}^{y - {D}_{1} ( t - 1 )} {\overline{F}}_{2} ( u ; t - {e}_{0} ) du + {\sum }_{t = 1}^{{e}_{0}} {\overline{G}}_{2} ( t - {b}_{2} ) ( {D}_{1} ( t ) - y {D}_{1} ( t - 1 ) )$$

When F̅₂ is piecewise linear, then the integrals in the expressions for EK₁ and EL₁ can be written explicitly as summations.

The last summation on the right hand side may equal zero if y≥D₁(e₀), which can be expected to be true in all practical cases.

EL₁ may represent the mean of missed subscribed shipments. To compute EL₁, the planning horizon d may be set to be equal to the longest possible planning horizon, d=sup{t≥b₁:P(b₂+W₂≥t)>0} and the following assumption may be used: TIP y satisfies y≥D₁(e₀). Thus, E(L₁|T₀)=(D₁(b₂+W₂)−D₁(T₀+e₀))I(T₀≤b₂+W₂−E₀). Under the assumption,

$${EL}_{1} = E ( {D}_{1} ( {b}_{2} + {W}_{2} ) - {D}_{1} ( {T}_{0} + {e}_{0} ) ) ; ( {T}_{0} \leq {b}_{2} + {W}_{2} - {e}_{0} ) = {\int }_{t = eo}^{d} P ( {T}_{0} \leq t - {e}_{0} ) P ( {W}_{2} > t - {b}_{2} ) {dD}_{1} ( t ) = {\int }_{t = eo}^{d} P ( {D}_{2} ( t - {e}_{0} ) \geq y - {D}_{1} ( t ) ) P ( {W}_{2} > t - {b}_{2} ) {dD}_{1} ( t ) {\int }_{u = {D}_{1} ( {e}_{0} )}^{{D}_{1} ( d )} P ( {D}_{2} ( H ( u ) ) \geq y - u ) P ( {W}_{2} > {D}_{1}^{- 1} ( u ) - {b}_{2} ) du$$

where H(u) is the time at which the u-th unit is encumbered.

Discretizing time in intervals of one day, and using discrete time setting assumption, the above expression may be written as:

$${EL}_{1} = {\sum }_{t = {e}_{0} + 1}^{d} {\int }_{u = {D}_{1} ( t - 1 )}^{{D}_{1} ( t )} P ( {D}_{2} ( t - {e}_{0} ) \geq y - u ) P ( {W}_{2} > t - {b}_{2} ) du = {\sum }_{t = {e}_{0} + 1}^{d} {\int }_{u = {D}_{1} ( t - 1 )}^{{D}_{1} ( t )} {\overline{F}}_{2} ( y - u ; t - {e}_{0} ) {\overline{G}}_{2} ( t - {b}_{2} ) du = {\sum }_{t = {e}_{0} + 1}^{d} {\overline{G}}_{2} ( t - {b}_{2} ) {\int }_{u = y - {D}_{1} ( t )}^{y - {D}_{1} ( t - 1 )} {\overline{F}}_{2} ( u ; t - {e}_{0} ) du . \qquad ( 5 )$$

When F̅₂ is piecewise linear (e.g., allowing linear interpolation between estimated quantiles), then the integrals above can be computed explicitly as summations. For this, the following notation may be used:

q(t)ϵ [symbol] ₊^{m}, vector containing the quantiles of the distribution of D₂(t). Here q₁(t)≤q₂(t)≤ . . . ≤qₘ(t).
f̅(t)ϵ [symbol] ^{m}, vector with tail probabilities corresponding to the quantiles in q(t),1=f̅₁(t)≥f̅₂(t) . . . ≥f̅ₘ(t)=0. (It is advisable to add 0-th and 100-th percentiles to the distribution provided by forecasting.) Here P(D₂(t)≥qᵢ(t))≥f̅ᵢ(t) and P(D₂(t)≤qᵢ(t))≥1−f̅ᵢ(t).

Then, the above expression of EL₁ may become:

EL₁=Σₜ₌ₑ_{₀}₊₁^{d}G̅₂(t=b₂)iplccdf(y−D₁(t),y−D₁(t−1),q(t−e₀),f̅(t−e₀)), (6)

where the function iplccdf(a, b, q, f̅) may be the integral between a and b of a piecewise linear complementary cdf (that may take the values in f̅ at the points in q) as further written below.

If the TIP y is very small, such that the TIP y assumption may not hold, then an additional term may be added leaving

$${EL}_{1} = {E ( {D}_{1} ( {e}_{0} ( {b}_{2} + {W}_{2} ) ) - y )}^{+} + {\sum }_{t = {e}_{0} + 1}^{d} {\overline{G}}_{2} ( t - {b}_{2} ) {\int }_{u = y - {D}_{1} ( t )}^{y - {D}_{1} ( t - 1 )} {\overline{F}}_{2} ( u ; t - {e}_{0} ) du = {\sum }_{t = 1}^{{e}_{0}} {G}_{2} ( t - {b}_{2} ) {( {D}_{1} ( t ) - y {D}_{1} ( t - 1 ) )}^{+} + {\sum }_{t = {e}_{0} + 1}^{d} {\overline{G}}_{2} ( t - {b}_{2} ) {\int }_{u = y - {D}_{1} ( t )}^{y - {D}_{1} ( t - 1 )} {\overline{F}}_{2} ( u ; t - {e}_{0} ) du . \\ Accordingly , \\ {EL}_{1} = {\sum }_{t = {e}_{0} + 1}^{d} {\overline{G}}_{2} ( t - {b}_{2} ) iplccdf ( y - {D}_{1} ( t ) , y - {D}_{1} ( t - 1 ) , q ( t - {e}_{0} ) , \overline{f} ( t - {e}_{0} ) ) + {\sum }_{t = 1}^{{e}_{0}} {G}_{2} ( t - {b}_{2} ) {( {D}_{1} ( t ) - y {D}_{1} ( t - 1 ) )}^{+} .$$

EK₁ may represent the mean of subscribed orders not encumbered on the first attempt. EK₁ may be expressed as:

$${EK}_{1} = {\int }_{u = 0}^{{\tilde{D}}_{1} ( d )} P ( {T}_{0} \leq H ( {\tilde{D}}_{1} ( d ) - u ) ) P ( {W}_{2} > H ( {\tilde{D}}_{1} ( d ) - u ) t - {b}_{2} ) du = {\int }_{u = 0}^{{D}_{1} ( d )} P ( {D}_{2} ( H ( {\tilde{D}}_{1} ( d ) - u ) ) \geq y - {\tilde{D}}_{1} ( d ) + u ) P ( {W}_{2} > H ( {D}_{1} ( d ) - u ) - {b}_{2} ) du = {\sum }_{t = 1}^{d} {\int }_{u = {\tilde{D}}_{1} ( d ) - {\tilde{D}}_{1} ( t )}^{u = {\tilde{D}}_{1} ( d ) - {\tilde{D}}_{1} ( t - 1 )} P ( {D}_{2} ( t ) \geq y - {\tilde{D}}_{1} ( d ) + u ) P ( {W}_{2} > t - {b}_{2} ) du = {\sum }_{t = 1}^{d} {\overline{G}}_{2} ( t - {b}_{2} ) {\int }_{u = y - {\tilde{D}}_{1} ( t )}^{y - {\tilde{D}}_{1} ( t - 1 )} {\overline{F}}_{2} ( u ; t ) du$$

When F₂(⋅; t) may be piecewise linear, the above expression of EK₁ may become:

$${EK}_{1} = {\sum }_{t = 1}^{d} {\overline{G}}_{2} ( t - {b}_{2} ) iplccdf ( y - {\tilde{D}}_{1} ( t ) , y - {\tilde{D}}_{1} ( t - 1 ) , q ( t ) , f ( t ) ) .$$

Revisiting the above objective function:

EOM_OF(TIP)=Σⱼg2ⱼ{(p₂+λ₂−cship₂)Emin(D₂,TIP−D₁(b₂+ω2ⱼ))−c(TIP−D₁(b₂+w2ⱼ))−θE(TIP−D₁(b₂+w₂ⱼ)−D₂)⁺+ENPV((TIP−D₁(b₂+w₂_{ⱼ})−D₂)+)} (1)

+(p₁−cship₁−c)Σⱼg₂ⱼD₁(b₂+w₂_{ⱼ}) (2)

+(p₂+λ₂−cship₂)Σⱼg₂ⱼ{E(D₂−TIP+D₁(b₂+w2ⱼ))⁺−E(D₂−TIP+\tilde{D}₁(b₂+w₂_{ⱼ}))⁺} (3)

+{−p₁+cship₁−λ₁}EL₁+(p₂+λ₂−cship₂)EK₁ (4).

The term in (1) may almost be exactly the same as an objective function restricted to a regular demand. One or the only difference may be that the TIP can be replaced by (TIP−D₁(b₂+w₂ⱼ)). Hence, this number may be different for each planning horizon scenario within the sum. The term in (2) may not have an effect on the decision, since this term may not depend on the TIP, and may be easy to compute. The term in (3) be computed as

$$( 3 ) = ( {p}_{2} + {λ}_{2} - {cship}_{2} ) {\sum }_{j} {g}_{2 j} {\int }_{u = TIP - {\tilde{D}}_{1} ( {b}_{2} + {w}_{2 j} )}^{TIP - {D}_{1} ( {b}_{2} + {w}_{2 j} )} {\overline{F}}_{2} ( u ; {b}_{2} + {w}_{2 j} ) du ,$$

The integration limits can be negative, which may be intended; the integrand may be 1 when u<0.) If the ccdf F⁻2 may be piecewise linear (e.g., linear interpolation between the quantiles provided by Forecasting may be used), then the term in (3) may become

$$( 3 ) = ( {p}_{2} + {λ}_{2} - {cship}_{2} ) {\sum }_{j} {g}_{2 j} iplccdf ( TIP - {\tilde{D}}_{1} ( {b}_{2} + {w}_{2 j} ) , TIP - {D}_{1} ( {b}_{2} + {w}_{2 j} ) , q ( {b}_{2} + {w}_{2 j} ) , \overline{f} ( {b}_{2} + {w}_{2 j} ) ) .$$

The two terms in (4) can be computed directly using the expressions for EL₁ and EK₁.

The function iplccdf (a, b, q, f̅) may be the integral of a piecewise linear complementary cdf (that may take the values in f̅ at the points in q) between a and b. This function may be computed as follows: given q, f̅ϵ [symbol] ^{m}, put iₒ=1 V #{i:a≥q₁} and i*=m [symbol] (1+#{i:b>q₁}). Then

$$iplccdf ( a , b , q , \overline{f} ) = {\sum }_{i = i ∘}^{{i}^{*} - 1} \frac{1}{2} ( {q}_{i +} - {q}_{i} ) ( {\overline{f}}_{i} + {\overline{f}}_{i + 1} ) - I ( a > {q}_{i ∘} ) ( a > {q}_{i ∘} ) ( {\overline{f}}_{i ∘} - \frac{a - {q}_{i ∘}}{{q}_{i ∘ + 1} - {q}_{i ∘}} \cdot \frac{( {\overline{f}}_{i ∘} + {\overline{f}}_{i {∘}_{+ 1}} )}{2} ) - I ( b < {q}_{{i}^{*}} ) ( {q}_{{i}^{*} + 1} - b ) ( {\overline{f}}_{{i}^{*}} + \frac{{q}_{{i}^{*}} - b}{{q}_{{i}^{*}} - {q}_{{i}^{*} - 1}} \cdot \frac{( {\overline{f}}_{{i}^{*} - 1} - {\overline{f}}_{{i}^{*}} )}{2} ) + I ( a < {q}_{1} ) \cdot ( min ( b , {q}_{1} ) - a ) .$$

a can be less than q₁ or negative (which may be meaningful); the last term may take care of the contribution of that portion to the integral.

Further, a bound on EL₁ may be imposed when, for example, the subscribed demand may have a constant rate and the lead time may be zero. In this particular case, there may be a simple bound on the expected backorders. This bound may use the following assumptions. {D₂(t)} may be assumed to be a square-integrable Lévy process with drift μ2. A Poisson process, a compound Poisson process, a Gamma process, and a Brownian motion with drift satisfy this assumption. D₁ may be assumed to have a constant rate, so D₁(t)=μ₁t (e.g., D₁ may not be peaky or experience day-of-month effects). Further, lead times may be assumed to be zero, and the initial inventory level (after the order may be placed) may be y. Under the various assumptions, the bound on EL₁ may be expressed as:

$${EL}_{1} \leq {E ( {D}_{2} ( d ) + {μ}_{1} d - y )}^{+} - \frac{{μ}_{2}}{{μ}_{2} + {μ}_{1}} {E ( {D}_{2} ( d ) + ( d + {e}_{0} ) {μ}_{1} - y )}^{+} .$$

Note that L₁=(D₂(d)+μ₁d−y)⁺−L₂. Note also that, under the last lead time assumption, encumbering inventory e₀ days in advance may have the same effect on L₂ as reducing the initial inventory y by μ₁e₀ and doing no encumbering. Hence,

$${EL}_{2} = \frac{{μ}_{2}}{{μ}_{2} + {μ}_{1}} {E ( {D}_{2} ( d ) + {μ}_{1} d - y + {μ}_{1} {e}_{0} )}^{+} ϵ ,$$

where ϵ≥0.

Further, under the last two assumptions, and assuming e₀=0 (no inventory encumbering allowed), then

$${EL}_{2} = \frac{{μ}_{2}}{{μ}_{2} + {μ}_{1}} {E ( {D}_{2} ( d ) + {μ}_{1} d - y )}^{+} + ɛ ,$$

where

$$0 \leq ϵ \leq \frac{{μ}_{1}}{{μ}_{1} + {μ}_{2}} P ( {T}_{0} \leq d ) {A}_{0} 0$$

and A₀ may be an upper bound on the amount shipped on any single regular customer order.

As a proof of this last expression, let T₀ represent the stockout time, T₀=inf{t≥0: D₂(t)≥y−μ₁t}=and put R=D₂(T₀)−y+μ₁T₀ (the “overshoot” at time T0). Since D₂(⋅) may be a Lévy process,

E(L₂|T₀)=μ₂(d−T₀)⁺+E(RI(T₀≤d)|T₀),

so that

EL₂=μ₂dP(T₀≤d)−μ₂E(T₀;T₀≤d)+E(R;T₀≤d).

Put M(t)=D₂(t)−μ₂t note (M(t):t≥0) may be a square-integrable martingale, and T₀ [symbol] d d may be a stopping time adapted to it (because D₁ may be deterministic). Using optional sampling,

$$0 = EM ( {T}_{0} d ) = E ( y - ( {μ}_{2} + {μ}_{1} ) {T}_{0} ; {T}_{0} \leq d ) + E ( {D}_{2} ( d ) - {μ}_{2} d ; {T}_{0} > d ) + E ( R ; {T}_{0} \leq d ) , = y P ( {T}_{0} \leq d ) - ( {μ}_{2} + {μ}_{1} ) E ( {T}_{0} ; {T}_{0} \leq d ) + E ( {D}_{2} ( d ) ; {T}_{0} > d ) - {μ}_{2} dP ( {T}_{0} > d ) + E ( R ; {T}_{0} \leq d ) = yP ( {T}_{0} \leq d ) - ( {μ}_{2} + {μ}_{1} ) E ( {T}_{0} ; {T}_{0} \leq d ) + E ( R ; {T}_{0} \leq d ) . \\ Hence , {μ}_{2} E ( {T}_{0} ; {T}_{0} \leq d ) = \frac{{μ}_{2}}{{μ}_{2} + {μ}_{1}} \{ yP ( {T}_{0} \leq d ) - E ( {D}_{2} ( d ) ; {T}_{0} \leq d ) + E ( R ; {T}_{0} \leq d ) \} .$$

Using this expression, then EL₂ can be derived as

$${EL}_{2} = \frac{{μ}_{2}}{{μ}_{2} + {μ}_{1}} \{ {μ}_{1} dP ( {T}_{0} \leq d ) - yP ( {T}_{0} \leq d ) + E ( {D}_{2} ( d ) ; {T}_{0} \leq d ) + ( {μ}_{1} \text{/} {μ}_{2} E ( R ; {T}_{0} \leq d ) \} = \frac{{μ}_{2}}{{μ}_{2} + {μ}_{1}} E ( {D}_{2} ( d ) + {μ}_{1} d - y ; {T}_{0} \leq d ) + ɛ , with 0 \leq ɛ = \frac{{μ}_{1}}{{μ}_{1} + {μ}_{2}} ERI ( {T}_{0} \leq d ) \leq \frac{{μ}_{1}}{{μ}_{1} + {μ}_{2}} P ( {T}_{0} \leq d ) {A}_{0} .$$

As previously explained, generating a decision for a total quantity (e.g., order up to quantity TIP) may additionally or alternatively use a service level constraint. In other words, rather than maximizing a profit, the minimum quantity (or some other function of the quantity) that may result in a desired service level may be set as the total quantity. For example, the desired service level for a subscription channel may be a certain percentage of on time shipments (e.g., 99%). A threshold may be derived from that service level (e.g., 100%−99%=1%). A loss associated with the subscription channel (e.g., canceled deterministic orders) may be an acceptable loss of the loss does not result in a violation of the threshold (e.g., the number of canceled deterministic orders cannot exceed 1% of the total number of deterministic orders). Accordingly, the total quantity of units of an item and the loss may be used as variable parameters, along a set of other variable parameters, to find an optimum solution that may meet the service level constraint. These and other features are further illustrated in FIGS. 8 and 9.

Turning to FIG. 8, the figure illustrates an example flow for generating a decision to acquire units of an item for storage in an inventory shared between a subscription channel and a regular channel. The decision may be based on balancing at least one loss parameter associated with the subscription channel with other parameters, such as a service level. In an example, the loss parameter may be used in an objective function as a variable parameter. The objective function may be configured to optimize a control parameter, such as to meet or exceed the service level, based on a number of variable parameters.

The example flow of FIG. 8 may start at operation 802, where a regular channel and a subscription channel may be facilitated. This operation may be similar to operation 602 of FIG. 6. In the interest of clarity of explanation, similarities may not be repeated herein.

At operation 804, a first quantity of units of an item may be estimated for the regular channel. For example, an inventory management system may access, receive, or compute an estimate of expected random orders to be received during a planning horizon. This estimate may be based on historical data related to past or historical random orders for the item, similar items, or items belonging to a same item category. Accordingly, the inventory management system may set the first quantity as a function of the estimate (e.g., at least equal to the number of expected random orders).

At operation 806, a look ahead window associated with the subscription channel may be identified. This operation may be similar to operation 604 of FIG. 6. In the interest of clarity of explanation, similarities may not be repeated herein.

At operation 808, a second quantity of units of the item may be estimated for the subscription channel based at least in part on the look ahead window. For example, the inventory management system may automatically generate deterministic orders ahead of time using a value of the look ahead window. Accordingly, the inventory management system may have an advanced forecast of the number of deterministic orders occurring during the planning horizon. The second quantity may be set as a function of the forecast (e.g., at least equal to the number of deterministic orders occurring during the planning horizon).

At operation 810, a service level constraint may be identified. The service level constraint may be associated with at least one of the two ordering channels. In an example, the service level constraint may be related to the subscription channel and may represent a desired quality of service. For instance, a 99% service level constraint may indicate that at least ninety nine percent of the deterministic orders should be shipped on time, or conversely, that no more than one percent of the deterministic orders should be delayed and/or canceled. Identifying the service level constraint may include, for example, receiving at the inventory management system data indication of the service level constraint. This data may be based on a service provider input specifying the constraint.

In the interest of clarity of explanation, the example flow of FIG. 8 illustrates a service level constraint of the subscription channel. Nevertheless, the example flow may not be limited as such. Instead, the example flow may similarly use a service level constraint of the regular channel, two service levels each corresponding to one of the ordering channels, or a combined service level corresponding to the two channels.

At operation 812, a third quantity of units of the item may be computed based on the service level constraint. The third quantity may represent a padding of the first and second quantities. In particular, because orders of the regular channel may be random, there could be a situation where a surge in these orders may result in a total consumption of the first quantity and the second quantity. This consumption may negatively impact the service level of the subscription channel because units of the item may no longer be available during the planning horizon. To protect against such a scenario, the third quantity may be used. In other words, by padding up the total quantity of units of the item by the third quantity, a likelihood of losing one or more deterministic orders during the planning horizon may be reduced.

However, increasing the total quantity independently of other parameters may not be efficient. For example, the larger the third quantity may be, the smaller the likelihood of losing deterministic orders may be. But also, the larger the holding cost may become, which may negate any benefit from the padding. As such, the third quantity may be computed as the smallest quantity that may allow the service level constraint to be met, while also balancing other parameters.

In an example, the inventory management system may compute the third quantity based on balancing a number of variable parameters and to optimize at least one control parameter. The control parameter may include the service level constraint. The variable parameters may include, for example, a loss associated with the subscription channel, holding cost, and other parameters. This loss may be computed using a similar process to the one described in connection with operations 606 and 708 of FIGS. 6 and 7, respectively. The similarities may not be repeated herein in the interest of clarity of explanation.

In an example, the inventory management system may initialize a total quantity of units of the item as a sum of the first quantity and the second quantity. Further, the inventory management system may receive, access, or compute an estimated regular demand and a forecast of subscribed demand during the planning, expressed as functions over time. Using the total quantity and the regular and subscribed demands, a stock-out point in time may be identified and accordingly, the loss may be computed. The loss may be balanced against the holding cost, and other variable parameters (e.g., revenue, profit, CIV, etc.), while also observing the service level constraint. For example, if the loss corresponds to an amount of canceled deterministic orders that may result in a violation of the service level constraint, the total quantity may be adjusted (e.g., increased) to reduce the loss. In this example, the adjustment may represent the third quantity. In another example, even if the loss may not result in a violation of the service level constraint, nonetheless the loss may be balanced against the holding cost. For example, the total quantity can be adjusted such that the loss may be minimized (e.g., by increasing the total quantity) while not exceeding the holding cost. Again, the adjustment may represent the third quantity in this example. FIG. 9 further illustrates an example flow that may be implemented in connection with computing the third quantity.

In an embodiment, computing the third quantity by balancing the loss with other variable parameters while observing the service level constraint may include using an objective function. In particular, the objective function may be configured to optimize a control parameter (e.g., the control parameter including the service level and the optimization including to meet, exceed, or maximize the service level) based on the variable parameters. The third quantity may be an output of the objective function.

At operation 814, a decision to store units of the item may be generated based on the first quantity, the second quantity, and the third quantity. For example, the inventory management system may generate the decision, where the decision may include a plan to acquire and store, during the planning horizon, a total quantity of units of item as a function of (e.g., equal to a sum of) the first, second, and third quantities.

As described herein above, padding up the total quantity of units of the item may include balancing a number of parameters while also observing the service level constraint. The example flow of FIG. 9 illustrates operations that may be implemented as part of determining the padding. Thus, some of the operations illustrated in FIGS. 8 and 9 may be similar. Such similarities may not be repeated herein in the interest of clarity of explanation.

The example flow of FIG. 9 may start at operation 902, where a quantity of units of an item may be initialized. For example, and similarly to operation 812, an inventory management system may set the quantity to be at least equal to the sum of a first quantity associated with a forecast of subscribed demand during a planning horizon and a second quantity associated with an estimate of regular demand expected during the planning horizon.

At operation 904, a loss associated with a subscription channel may be computed. This loss may be associated with a likelihood of losing a deterministic order during the planning horizon. For example, the inventory management system may compute a stock-out point in time based on the quantity, the regular demand, and the subscribed demand. Using the stock-out point in time and the subscribed demand, the inventory management system may also compute the loss.

At operation 906, a service level may be computed based on the loss. The inventory management system may use the loss, as at least one parameter, to adjust the quantity and, accordingly, increase the service level beyond an acceptable threshold. In particular, losing a deterministic order may impact a service level of the subscription channel. That may be because losing the deterministic order may result in an order cancellation. As such, the higher the number of lost (or canceled) deterministic orders may be, the lower the service level may be. In an example, the inventory management may compute the service level as a function (e.g., equal to) of lost deterministic orders relative to the total number of deterministic orders.

At operation 908, the service level may be compared to a threshold. The threshold may be based on a service level constraint specifying an acceptable quality of service (e.g., 99% on time shipment). By comparing the service level to the threshold, the inventory management system may determine whether the quantity should be adjusted. If so, operation 910 may be followed to adjust the quantity based on balancing the loss with a set of parameters. Otherwise, operation 912 may be performed to generate a decision based on the quantity.

At operation 910, a quantity of the item may be adjusted. For example, the inventory management system may have determined that the service level may be unacceptable (e.g., not meeting or exceeding the threshold). By increasing the quantity, a higher number of units of item may become available in the shared inventory. Accordingly, the likelihood of lost or canceled deterministic orders (and random orders) may decrease, which may result in an increase in the service level. In an example, adjusting the quantity may include finding the smallest quantity increase that may result in the service level meeting or exceeding the threshold. For instance, the inventory management system may increase the quantity by a certain amount (e.g., one unit) and iteratively repeat operations 904-908 as needed.

In another example, the inventory management system may adjust the quantity by balancing the loss with the other parameters, such as holding cost and/or revenue, while also ensuring that the resulting service level may meet or exceed the threshold. To do so, the inventory management system may provide the loss as a variable parameter to an objective function. The objective function may be configured to optimize a control parameter (e.g., maximize the service level) by balancing the loss with other variable parameters (e.g., holding cost, revenue, CIV, and other inventory-related parameters). An example objective function is further described herein below.

At operation 912, a decision to store the adjusted quantity may be generated. At this operation, the inventory management system may have determined a quantity of units of the item, adjusted as needed, that may result in the service level meeting or exceeding the threshold. Accordingly, the inventory management system may generate a decision for a plan to acquire and store, during the planning horizon, a total quantity of units of item as a function of (e.g., equal to a sum of) the first, second, and third quantities.

An illustrative objective function may be similar to the objective function described in connection with the example flow of FIG. 7. In the case of a service level constraint, it may be sufficient to compute E L₁ as a function of the TIP y, and perform a line search to find the minimum y that guarantees E L₁≤ηE D₁(b₂+W₂), where η may represent an acceptable threshold. In the relevant search region, the TIP assumption (e.g., TIP y satisfies y≥D₁(e₀)) may hold. As such, E L₁ may be evaluated from equations (5) and (6). From equation (5), the derivative of E B₁ with respect toy for y≥D₁(e₀) may be written as:

$$\frac{\partial {EL}_{1}}{\partial y} = {\sum }_{t = {e}_{0} + 1}^{d} {\overline{G}}_{2} ( t - {b}_{2} ) \{ {\overline{F}}_{2} ( y - {D}_{1} ( t - 1 ) ; t - {e}_{0} ) - {\overline{F}}_{2} ( y - {D}_{1} ( t ) ; t - {e}_{0} ) \} .$$

The derivative can be useful when performing the line search, if using a Newton-Raphson variant.

As illustrated in the example flows of FIGS. 6-9, generating a decision for a total quantity of units of an item (e.g., order up to quantity TIP) may use a loss-revenue approach and/or a loss-service level approach. Regardless of the approach, the total quantity may allow an inventory to be shared between ordering channels of different types. In certain situations, further inventory-related efficiencies may be derived from analyzing the total quantity. The analysis may be triggered by an event. An example event may include a forecasted spike in subscribed demand occurring during a planning horizon as illustrated in FIG. 10. Another example event may include a total quantity larger, by a certain degree, than a sum of individual quantities necessary to support each ordering channel separately (e.g., a total quantity twice, or some other multiplier of, the sum of the first quantity and the second quantity described in connection with the example flows of FIGS. 8 and 9). In such situations, the additional efficiencies may be accomplished by splitting the total quantity in at least two orders. The first order may include a first quantity of units of the item to be stored during a first time period of the planning horizon. The second order may include a second quantity of units of the item to be stored during a second time period of the planning horizon. In an example, the first and second time periods may span the entire planning horizon. In this example, the sum of the first quantity and the second quantity may be smaller than the total quantity. Accordingly, efficiency may be accomplished by acquiring and storing a smaller quantity than what would have been planned for if no splitting was performed. An example flow for splitting the total quantity is further illustrated in FIG. 11.

Turning to FIG. 10, the figure illustrates an example trigger event for splitting a total quantity. In particular a spike 1002 in subscribed demand 1004 is illustrated. The subscribed demand 1004 may represent an amount of deterministic orders that may have been automatically generated on behalf of subscribed consumers based on a look ahead window. The spike 1002 may include a sudden large increase 1006 followed by a sudden large decrease 1008 (not necessarily equivalent to the increase) of the subscribed demand 1004 occurring during a relatively short period of time of the planning horizon 1010. If the subscribed demand 1004 is expressed as a function, the spike 1002 can be determined based on changes in the derivative or slope of the function. Although FIG. 10 illustrates a spike occurring near the end of a planning horizon, this spike may occur at any point in time during the planning horizon (e.g., shortly after the start of the planning horizon, or at any other point).

When a spike 1002 may be detected, a time window 1012 around the spike 1002 may be defined. For example, the time window 1012 may be set as the time between the start and the end of the spike 1002 (e.g., the start of the increase and the end of the decrease). In another example, the time window 1012 may be set as a range around the start and the end (e.g., a number of days earlier than the start and a number of days later than the start). In yet another example, the time window 1012 may be set a function of the look ahead window and the spike 1002 (e.g., the time window 1012 may be equal to or a fraction of the look ahead window and may be centered around the spike 1002). As such, remaining time period 1014 of the planning horizon may not include the spike 1002.

Although FIG. 10 illustrates one remaining time period 1014, there may be a larger number of such remaining time periods based on when the spike 1012 may occur. For example, when the spike 1002 may occur at the middle of planning horizon and a time window 1012 may be accordingly defined, a first remaining time period may occur between the start of the planning horizon and the start of the time window 1012 and a second remaining time period may occur between the end of the time window 1012 and the end of the planning horizon. In such a case, the total quantity may be split in three orders, one corresponding to the time window 1012 and two corresponding to the remaining time periods.

Further, although FIG. 10 illustrates a single spike 1002, a larger number of spikes may occur during the planning horizon. Accordingly, multiple time windows and one or more remaining time periods may be defined and may result in corresponding orders. Spikes may also not be limited to subscribed demand. Instead, similar spikes may be observed and defined for expected regular demand.

Turning to FIG. 11, the figure illustrates an example flow for splitting a total quantity into multiple orders based on a trigger event. In the interest of clarity of explanation, the example flow illustrates splitting the total quantity in two orders in the context of a subscription channel and a regular channel. However, the example flow may not be limited as such. Instead, the example flow may similarly apply to splitting a total quantity in a larger number of orders and/or for any number of different ordering channels.

The example flow of FIG. 11 may start at operation 1102, where a trigger event may be detected. The trigger event may be associated with a decision to store a total quantity of units of an item in shared inventory of a subscription channel and a regular channel during a planning horizon. For example, an inventory management system may detect or receive a notification of a spike in a forecast of subscribed demand as illustrated in FIG. 10. In another example, the inventory management system may detect or receive a notification that the total quantity may be larger by a certain degree than a sum of individual quantities necessary to independently support the two ordering channels.

At operation 1104, a time window may be set relative to the planning horizon. The time window may be based on the trigger event. For example, if the trigger event indicates a spike, the inventory management system may set the time window around the occurrence of the spike during the planning horizon as illustrated in FIG. 10. In another example, if the trigger event indicates a large total quantity, the time window may be set as a later time occurring during the planning horizon (e.g., the last few days or some other time amount of the planning horizon). In this example, the later time (and the associated quantity as further described at operation 1106) may be set to prevent regular demand from depleting the associated quantity before encumbering a portion of the associated quantity for the subscribed demand.

At operation 1106, a first order to store a first quantity of units of the item during the time window may be generated. This first quantity may be used to meet subscription demand of the subscription channel during the time window, while also reducing a risk of canceled subscription demand during the time window. In one example, reducing this risk can be achieved by a combination of the first quantity and the time window. In other words, by setting the time window such that the first quantity may arrive just in time to support a spike in subscribed demand and by setting the first quantity as the minimally sufficient quantity to meet the spike in the subscribed demand, the risk can be reduced or even eliminated. In another example, reducing the disk can be achieved by a reserving the first quantity to the subscription channel during the time window. In other words, although stored in the shared inventory, the first quantity may be available for use of only the subscription channel. This may ensure that, for example, the spike in the subscribed demand may be met when the trigger event may indicate a spike. This approach may also allow for a smaller total padding when the trigger event may indicate a large total quantity.

The inventory management system may compute the first quantity based on the trigger event. For example, if the trigger event indicates a spike in the subscribed demand, the inventory management system may compute the corresponding amount of deterministic orders and may set the first quantity as a function of this amount (e.g., at least equal to).

In another example, if the trigger event indicates a large total quantity, the inventory management system may compute the individual quantities necessary to independently support the two ordering channels, similarly to operations 804 and 808 of the example flow of FIG. 8. Based on the total quantity and these individual quantities, the inventory management system may set the first quantity. For ease of reference, the following notations may be used. y may represent the total quantity. TIP₂ may represent the individual quantity of the regular channel over the planning horizon. q₁ may represent the individual quantity of the subscription channel over the planning horizon. \tilde{y} may represent a second quantity to be ordered to support the two ordering channels during the remaining time period of the planning horizon as further described at operation 1108. \tilde{q}₁ may represent the necessary individual quantity to support the subscribed demand during the remaining time period (e.g., while q₁ may correspond to the total of the subscribed demand over the planning horizon, \tilde{q}₁ may correspond to the subscribed demand during the remaining time period). As such, the inventory management system may compute the first quantity as y−\tilde{y}, where \tilde{y}≥TIP₂+\tilde{q}₁ and y≥TIP₂+q₁.

At operation 1108, a second order to store a second quantity of units of the item during the remaining time period may be generated. The second quantity may be shared between the subscription channel during the remaining time period. The inventory management system may compute the second quantity (noted as \tilde{y}) based on the trigger event. For example, if the trigger event indicates a spike in the subscribed demand, the inventory management system may compute the first quantity (notes as y−\tilde{y}) as described at operation 1106 and may consider the remaining time period as a pseudo-planning horizon. The inventory management system may re-compute a total quantity based on the pseudo-planning horizon by using any of the example flows of FIGS. 6-9. This re-computed total quantity may be set at the second quantity.

In another example, if the trigger event indicates a large total quantity, the inventory management system may compute the second quantity (\tilde{y}) based on the individual quantity of the regular channel over the planning horizon (TIP₂) and the individual quantity to support the subscribed demand during the remaining time period (\tilde{q}₁, where \tilde{q}₁ may at least be equal to the amount of deterministic orders occurring during the remaining time period). For instance, the inventory management system may compute the second quantity (\tilde{y}) as \tilde{y}≥TIP²+\tilde{q}₁. A further approach of computing the second quantity (\tilde{y}) in this example is illustrated herein next.

More particularly, the strategy of this approach may include reducing the amount of padding by scheduling a second delivery at an appropriately chosen time. Because there may be costs associated with the additional delivery, this approach would be applied when the total quantity may be too large. For example, this approach may be used when

$$( \frac{y}{{TIP}_{2} + {D}_{1} ( d )} - 1 ) \geq θ ,$$

for some pre-specified threshold θ (e.g., θ=40%).

The decision variables may include the total quantity y, the first quantity (y−\tilde{y}) that should be deferred to a late shipment, and the time \tilde{t} of that deferred shipment (e.g., the time window). To simplify the computation, rather than optimizing over \tilde{t}, a simple heuristic may be used when the following conditions may be met:
Lead times may have small variability.
The encumbrance period e₀ may not be too small a fraction of the planning horizon. (e.g., more than 20 or 25%).

The heuristic may include
1. Set d=sup{t:P(W₂+b₂>t)>0}, the longest possible planning horizon.
2. If d<2e₀, then set \tilde{y}=TIP₂+D₁(0,e₀), z*=D₁(e₀,d), and go to step 6. (In this case, there may be no backorders/losses of subscribed orders after time b₁+W₁, and there may be zero padding.) Else, go to step 3.
3. Apply similar operations as the ones described in connection with the example flow of FIGS. 8 and 9, but with planning horizon \tilde{d}=d−e₀.
   Let \tilde{y} be the order up-to-level selected by applying these operations and \tilde{w}=E L₁(0,d−e₀) be the expected lost/backordered subscribed orders by time d−e₀. (Which will be less than ηD₁(d−e₀), since Approach 1 ensures that.)
4. If subscribed demand can be backordered (rather than lost), put z*=D₁(d−e₀,d) and go to step 6.
   Else, go to step 5.
5. Perform a line search on z=y−\tilde{y}, the amount to be delivered at time d−e₀, to solve

z*=min z

s.t.E B₁(d−e₀,d)≤ηD₁(d−e₀,d),

z≥D₁(d−e₀,d)

Here E B₁(d−e₀,d) may represent subscribed backordered demand over (d−e₀,d). (If subscribed demand is lost rather than backordered, then there may be no losses over this interval, L₁(d−e₀,d)=0. But if subscribed demand can be backordered, then this term may be non-trivial.)
6. Result: The order-up-to level may be y=\tilde{y}+z*. If the supply is x, then \tilde{y}−x units should be ordered for delivery as soon as possible (at time b₁+W₁), and z* units to be delivered at time max(d−e₀,d).
   In Step 5, E B₁(d−e₀,d), the expected backorders of subscribed demand over the interval (d−e₀,d) should be evaluated as a function of z.

Evaluating E B₁(d−e₀,d) may depend on whether lead times may be deterministic or random. When the lead times may be deterministic, E B₁(d−e₀,d) may be computed as following:

$$\begin{matrix}{EB}_{1} ( d - {e}_{0} , d ) = {\int }_{u = {D}_{1} ( {e}_{0} )}^{{D}_{1} ( d ) - z} {\overline{F}}_{2} ( y - z - u ; H ( u ) ) du \\ = {\sum }_{t = {e}_{0} + 1}^{h ( z ) - 1} {\int }_{u = \tilde{y} - {D}_{1} ( t )}^{\tilde{y} - {D}_{1} ( t - 1 )} {\overline{F}}_{2} ( u ; t - {e}_{0} ) du + \\ {\int }_{u = \tilde{y} - {D}_{1} ( d ) + z}^{\tilde{y} - {D}_{1} ( h ( z ) - 1 )} {\overline{F}}_{2} ( u ; h ( z ) - {e}_{0} ) du\end{matrix}$$

where h(z)=┌D₁⁻¹(D₁(d)−z)┐ is the day in which the (D₁(d)−z)-th unit of subscribed demand that should be shipped. If F̅₂ is piecewise linear, then the above integrals can be written explicitly as sums as shown in equation (7) herein below. From the above equation, it follows that the derivative of E B₁(d−e₀,d) with respect to z may be:

$$\frac{\partial {EB}_{1} ( d - {e}_{0} , d )}{\partial z} = - {\overline{F}}_{2} ( \tilde{y} - {D}_{1} ( d ) + z ; h ( z ) - {e}_{0} ) .$$

This expression can be useful when performing a line search in Step 5 above.

If the lead times are random, t E B₁(d−e₀,d) can be computed as following:

$$\begin{matrix}{EB}_{1} ( d - {e}_{0} , d ) = {\int }_{u = {D}_{1} ( {e}_{0} )}^{{D}_{1} ( d ) - z} {\overline{F}}_{2} ( \tilde{y} - u ; H ( u ) ) {\overline{G}}_{2} ( {D}_{1}^{- 1} ( u + z ) - {b}_{2} ) du \\ = {\sum }_{t = {e}_{0} + 1}^{h ( z ) - 1} {\int }_{u = \tilde{y} - {D}_{1} ( t )}^{\tilde{y} - {D}_{1} ( t - 1 )} {\overline{F}}_{2} ( u ; t - {e}_{0} ) \\ {\overline{G}}_{2} ( {D}_{1}^{- 1} ( \tilde{y} + z - u ) - {b}_{2} ) du + \\ {\int }_{u = \tilde{y} - {D}_{1} ( d ) + z}^{\tilde{y} - {D}_{1} ( h ( z ) - 1 )} {\overline{F}}_{2} ( u ; h ( z ) - {e}_{0} ) \\ {\overline{G}}_{2} ( {D}_{1}^{- 1} ( \tilde{y} + z - u ) - {b}_{2} ) du .\end{matrix}$$

Further, when using the heuristic, the following assumptions may be made. First, d>2e₀ (as noted earlier, if the opposite is true, the problem may become easy and there may be no backorders after time b₁+W₁). Second, z≤D₁ (e₀,d) (since that may be enough to guarantee no backorders after time d−e₀). The second shipment may be delivered at time d−e₀; as long as this shipment may be large enough, inventory for all remaining subscribed demand may be encumbered at that time, and hence no backorders may take place after receiving this shipment. However, if there were too many backorders before time d−e₀, part of the second shipment may be used to fulfill those, and if too little is left, then there may be backorders after the second shipment.

If lead times are deterministic (e.g., W₁ is deterministic) so that d=b₂+W₁, then

$$\begin{matrix}{EB}_{1} ( d - {e}_{0} , d ) = {\int }_{u = 0}^{∞} P ( {B}_{1} ( d - {e}_{0} , d ) > u ) du \\ = {\int }_{u = 0}^{{D}_{1} ( d ) - z - {D}_{1} ( {e}_{0} )} P ( {B}_{1} ( d - {e}_{0} , d ) > u ) du \\ = {\int }_{u = 0}^{{D}_{1} ( d ) - z - {D}_{1} ( {e}_{0} )} P ( {T}_{0} \leq H ( {D}_{1} ( d ) - z - u ) ) du \\ = {\int }_{u = 0}^{{D}_{1} ( d ) - z - {D}_{1} ( {e}_{0} )} \\ P ( {D}_{2} ( H ( {D}_{1} ( d ) - z - u ) ) \geq y - {D}_{1} ( d ) + u ) du \\ = {\int }_{u = {D}_{1} ( {e}_{0} )}^{{D}_{1} ( d ) - z} P ( {D}_{2} ( H ( u ) ) \geq y - z - u ) du \\ = {\int }_{u = {D}_{1} ( {e}_{0} )}^{{D}_{1} ( d ) - z} {\overline{F}}_{2} ( y - z - u ; H ( u ) ) du .\end{matrix}$$

In the first equation above, some backorders may be double counted corresponding to subscribed demand that may have been backordered before time d−e₀ and that remains backordered after that time (the shipment received may have been insufficient to fulfill it). To avoid such double counting, the upper integration limit in this equation can be replaced by (D₁(d)−z−D₁(e₀)) [symbol] (D₁(d)−D₁(d−e₀)).

By discretizing time in intervals of one day, and using the discrete time setting assumption, the last equation above may become:

$$\begin{matrix}EB 1 ( d - {e}_{0} , d ) = {\sum }_{t = {e}_{0} + 1}^{h ( z ) - 1} {\int }_{u = {D}_{1} ( t - 1 )}^{{D}_{1} ( t )} {\overline{F}}_{2} ( y - z - u ; t - {e}_{0} ) du + \\ {\int }_{u = {D}_{1} ( h ( z ) - 1 )}^{{D}_{1} ( d ) - z} {\overline{F}}_{2} ( y - z - u ; h ( z ) - {e}_{0} ) du \\ = {\sum }_{t = {e}_{0} + 1}^{h ( z ) - 1} {\int }_{u = \tilde{y} - {D}_{1 ( t )}}^{\tilde{y} - {D}_{1} ( t - 1 )} {\overline{F}}_{2} ( u ; t - {e}_{0} ) du + \\ {\int }_{u = \tilde{y} - {D}_{1} ( d ) + z}^{\tilde{y} - {D}_{1} ( h ( z ) - 1 )} {\overline{F}}_{2} ( u ; h ( z ) - {e}_{0} ) du ,\end{matrix}$$

where h(z)=┌D₁⁻¹(D₁(d)−z)┘ is the day in which the (D₁(d)−z)-th unit of subscribed demand that should be shipped.

When F̅₂ may be piecewise linear, the integrals above can be written as summations:

$${EB}_{1} ( d - {e}_{0} , d ) = {\sum }_{t = {e}_{0} + 1}^{h ( z ) - 1} iplccdf ( \tilde{y} - {D}_{1} ( t ) , \tilde{y} - {D}_{1} ( t - 1 ) , q ( t - {e}_{0} ) , \overline{f} ( t - {e}_{0} ) ) + iplccdf ( \tilde{y} - {D}_{1} ( d ) + z , \tilde{y} - {D}_{1} ( h ( z ) - 1 , q ( h ( z ) - {e}_{0} ) , \overline{f} ( h ( z ) - {e}_{0} ) ) . \qquad ( 7 )$$

If lead times are random, E B₁(d−e₀,d) can become:

$$\begin{matrix}{EB}_{1} ( d - {e}_{0} , d ) = {\int }_{u = {D}_{1} ( {e}_{0} )}^{{D}_{1} ( d ) - z} {\overline{F}}_{2} ( \tilde{y} - z - u ; H ( u ) ) {\overline{G}}_{2} ( {D}_{1}^{- 1} ( u + z ) - {b}_{2} ) du , \\ = {\sum }_{t = {e}_{0} + 1}^{h ( z ) - 1} {\int }_{u = \tilde{y} - {D}_{1} ( t )}^{\tilde{y} - {D}_{1} ( t - 1 )} {\overline{F}}_{2} ( u ; t - {e}_{0} ) \\ {\overline{G}}_{2} ( {D}_{1}^{- 1} ( \tilde{y} - u ) - {b}_{2} ) du + \\ {\int }_{u = \tilde{y} - {D}_{1} ( d ) + z}^{\tilde{y} - {D}_{1} ( h ( z ) - 1 )} {\overline{F}}_{2} ( u ; h ( z ) - {e}_{0} ) \\ {\overline{G}}_{2} ( {D}_{1}^{- 1} ( \tilde{y} - u ) - {b}_{2} ) du\end{matrix}$$

When F̅₂ may be piecewise linear the integrals above can be written as summations. However, the term G̅₂(D₁⁻¹(y−u)−b₂) cannot be brought out of the integral, since it may be potentially non-constant within each set of integration limits.

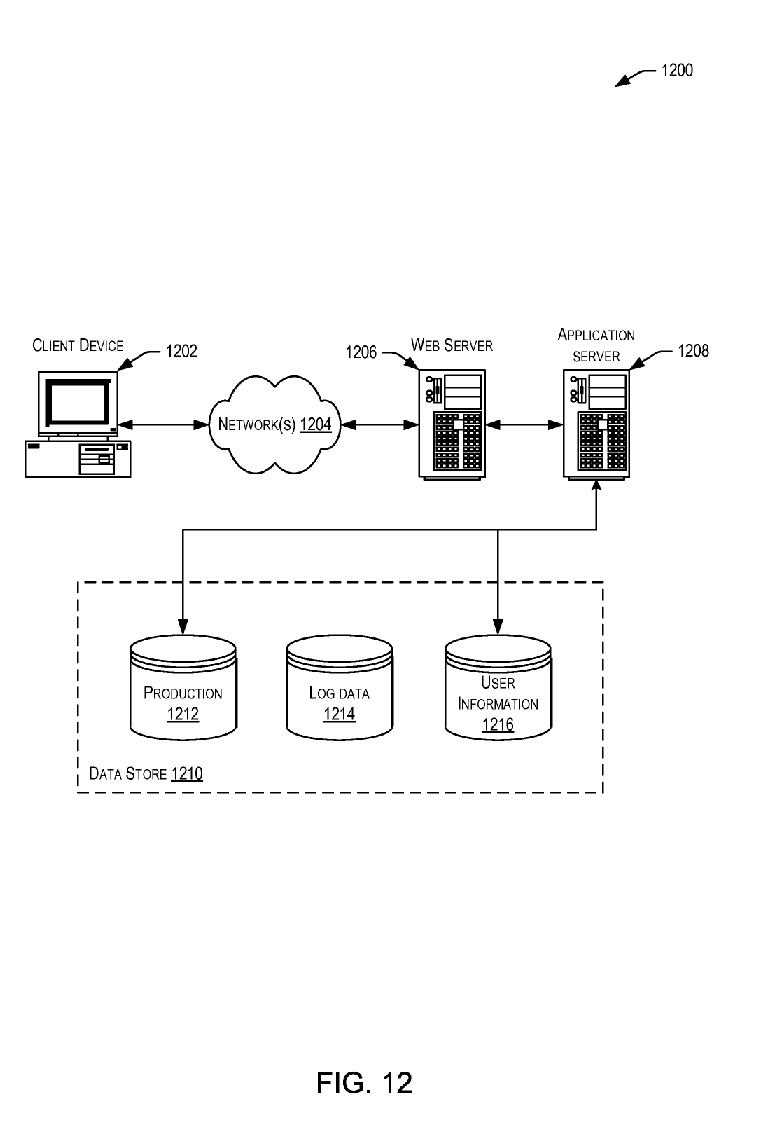

Turning to FIG. 12, the figure illustrates aspects of an example environment 1200 capable of implementing the above-described structures and functions. As will be appreciated, although a Web-based environment is used for purposes of explanation, different environments may be used, as appropriate, to implement various embodiments. The environment includes an electronic client device 1202, which can include any appropriate device operable to send and receive requests, messages, or information over an appropriate network(s) 1204 and convey information back to a user of the device. Examples of such client devices include personal computers, cell phones, handheld messaging devices, laptop computers, set-top boxes, personal data assistants, electronic book readers, wearable computing devices, or any other computing device. In some embodiments, consumers 440 and/or merchants 430 as shown in FIG. 4 may use such electronic client devices to communication with the service provider 110. The network(s) 1204 can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, and the environment includes a network server 1206 for receiving requests and serving content in response thereto, although for other networks an alternative device serving a similar purpose could be used as would be apparent to one of ordinary skill in the art.

The illustrative environment includes at least one application server 1208 and a data store 1210. In some embodiments, the inventory management system described herein above may be implemented using such an application server. It should be understood that there can be several application servers, layers, or other elements, processes or components, which may be chained or otherwise configured, which can interact to perform tasks such as obtaining data from an appropriate data store. As used herein the term “data store” refers to any device or combination of devices capable of storing, accessing, and/or retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device, handling a majority of the data access and business logic for an application. The application server 1208 provides access control services in cooperation with the data store 1210, and is able to generate content such as text, graphics, audio files and/or video files to be transferred to the user, which may be served to the user by the Web server in the form of HTML, XML or another appropriate structured language in this example. The handling of all requests and responses, as well as the delivery of content between the client device 1202 and the application server 1208, can be handled by the network server 1206. It should be understood that the network and application servers 1206 and 1208 are not required and are merely example components, as structured code discussed herein can be executed on any appropriate device or host machine as discussed elsewhere herein.

The data store 1210 can include several separate data tables, databases or other data storage mechanisms and media for storing data relating to a particular aspect. For example, the data store 1210 illustrated includes mechanisms for storing production data 1212 and user information 1216, which can be used to serve content for the production side. The data store 1210 is also shown to include a mechanism for storing log data 1214, which can be used for reporting, analysis, or other such purposes. In some embodiments, the inventory data store 1212 as shown in FIG. 2 is implemented in such a data store. It should be understood that there can be many other aspects that may need to be stored in the data store 1210, such as for page image information and to access correct information, which can be stored in any of the above listed mechanisms as appropriate or in additional mechanisms in the data store 1210. The data store 1210 is operable, through logic associated therewith, to receive instructions from the application server 1208 and obtain, update or otherwise process data in response thereto. In one example, a user might submit a search request for a certain type of item. In this case, the data store might access the user information to verify the identity of the user, and can access the catalog detail information to obtain information about items of that type. The information then can be returned to the user, such as in a results listing on a network page that the user is able to view via a browser on the client device 1202. Information for a particular item of interest can be viewed in a dedicated page or window of the browser.

Each server typically will include an operating system that provides executable program instructions for the general administration and operation of that server, and typically will include a non-transitory computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available, and are readily implemented by persons skilled in the art, particularly in light of the disclosure herein.

The environment in one embodiment is a distributed computing environment utilizing several computer systems and components that are interconnected via communication links, using one or more computer networks or direct connections. However, it will be appreciated by those of skilled in the art that such a system could operate equally well in a system having fewer or a greater number of components than are illustrated in FIG. 12. Thus, the depiction of environment 1200 in FIG. 12 should be taken as being illustrative in nature, and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more Web applications that may be implemented as one or more scripts or programs written in any programming language, such as JAVA®, C, C# or C++, or any scripting language, such as Perl, Python or TCL, as well as combinations thereof. The server(s) may also include database servers, including without limitation those commercially available from Oracle Corporation, Microsoft Corporation, SAP AG, and International Business Machines Corporation.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.) and working memory as described above. The non-transitory computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, or software (including portable software, such as applets) implemented by hardware. Further, connection to other computing devices such as network input/output devices may be employed.

Non-transitory storage media and computer-readable media for containing code, or portions of code, can include any appropriate media known or used in the art, including storage media and communication media such as, but not limited to, volatile and non-volatile, removable and non-removable media implemented in any method or technology for storage and/or transmission of information such as computer-readable instructions, data structures, program modules or other data, including RAM, ROM, EEPROM, flash memory or other memory technology, CD-ROM, DVD, or other optical storage, magnetic cassettes, magnetic tape, magnetic disk storage or other magnetic storage devices or any other medium which can be used to store the desired information and which can be accessed by a system device. Based on the disclosure and teachings provided herein, a person of skilled in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as that included in the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z in order for each to be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Embodiments of this disclosure are described herein, including the best mode known to the inventors for carrying out the disclosure. Variations of those embodiments may become apparent to those skilled in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A computer-implemented method for generating, at a particular point in time, a decision to store during a planning horizon occurring after the particular point in time, units of an item in storage associated with an electronic marketplace, the computer-implemented method comprising:
receiving, by an inventory management system that comprises a computer system hosting a database, data associated with a regular channel and a subscription channel, wherein:
the regular channel enables a regular order to be placed, at any point in time, for at least one unit of the item from the storage,
the subscription channel enables a subscription to be placed for the item from the storage,
the regular channel and the subscription channel share the storage that stores the units of the item,
the database hosted on the computer system tracks orders of the units of the item for both the regular channel and the subscription channel, and
the inventory management system controls decisions about inventorying the item in the storage;
generating, by the inventory management system based at least in part on the data received, a subscription order for at least one unit of the item, wherein the subscription order is generated ahead of the particular point in time based at least in part on a look ahead window associated with the subscription channel, wherein
the look ahead window specifies a time period during which subscription orders can be placed on behalf of corresponding subscribed customers, and
the time period occurs prior to the particular point in time for generating the decision to store, during the planning horizon, the units of the item;
estimating, by the inventory management system based at least in part on the look ahead window, a first loss from a canceled subscription order for at least one unit of item and a second loss from a lost regular order for at least one unit of the item, the canceled subscription order and the lost regular order expected within the planning horizon; and
generating, by the inventory management system at the particular point in time occurring after the subscription order has been generated, the decision to store, during the planning horizon, the units of the item in the storage, wherein the decision is generated based at least in part on the first loss and the second loss, and wherein the decision causes the units of the item to be stored in the storage in support of shared usage of the storage by the regular channel and the subscription channel during the planning horizon.

2. The computer-implemented method of claim 1, wherein a set of units of the item is not reserved in storage for either the subscription channel or the regular channel.

3. The computer-implemented method of claim 1, wherein generating the decision comprises balancing the first loss and the second loss with a set of parameters, wherein the set of parameters comprises at least one of a holding cost or revenue.

4. The computer-implemented method of claim 3, wherein generating the decision comprises increasing a quantity of the units of the item to decrease the first loss and the second loss without exceeding the holding cost.

5. One or more non-transitory computer-readable storage media storing computer-executable instructions that, when executed by a computing system of an inventory management system, configure the computing system to perform operations comprising:
accessing data associated with a first ordering channel and a second ordering channel, the first ordering channel enabling random orders to be placed for an item offered at a network-based resource from a storage space, the second ordering channel enabling deterministic orders to be generated for the item offered at the network-based resource from the storage space, the first ordering channel and the second ordering channel share storage in the storage space, a database hosted on the computer system tracking orders of the item for both the first ordering channel and the second ordering channel, and the inventory management system controlling decisions about inventorying the item in the storage;
generating, based on the data that is accessed, a deterministic order associated with the second ordering channel, the deterministic order generated at a point in time based at least in part on a value for a look ahead window associated with the second ordering channel, the value for the look ahead window indicating a shift in time at which the deterministic orders for the item can be automatically generated;
computing, based at least in part on the value for the look ahead window, a first loss associated with losing a random order that could have been placed at the first ordering channel and a second loss associated with canceling the deterministic order that has been generated; and
generating a decision to store units of the item so that the network-based resource can offer the item as available, the decision generated based at least in part on the first loss and the second loss, the decision causing the units of the item to be stored in the storage in support of shared usage of the storage by the first ordering channel and the second ordering channel.

6. The one or more non-transitory computer-readable storage media of claim 5, wherein determining the value for the look ahead window comprises:
setting the value to a first time;
estimating the first loss and the second loss based at least in part on the first time;
determining a first profit based at least in part on the first loss and the second loss;
setting the value to a second time;
re-estimating the first loss and the second loss based at least in part on the second time;
determining a second profit based at least in part on the first loss and the second loss that are re-estimated;
setting the value as the first time if the first profit exceeds the second profit; and
setting the value as the second time if the second profit exceeds the first profit.

7. The one or more non-transitory computer-readable storage media of claim 5, wherein the value for the look ahead window indicating the shift in time reduces a likelihood of a portion of the deterministic orders being canceled by enabling an advanced forecast of the deterministic orders.

8. The one or more non-transitory computer-readable storage media of claim 5, wherein the second ordering channel is associated with a period of peak demand for the deterministic orders, wherein the shift in time indicated by the value for the look ahead window enables the deterministic orders to be generated prior to the period of the peak demand.

9. The one or more non-transitory computer-readable storage media of claim 5, wherein a first quality of service associated with the second ordering channel is increased based at least in part on reducing a likelihood of a portion of the deterministic orders being canceled.

10. The one or more non-transitory computer-readable storage media of claim 5, wherein computing the second loss comprises:
determining an amount of the deterministic orders based at least in part on the value of the look ahead window;
generating an expected amount of the random orders;
setting a potential quantity of the units of the item to store;
computing an estimated amount of the deterministic orders to be canceled based at least in part on the amount of the deterministic orders, the expected amount of the random orders, and the potential quantity of the units of the item; and
computing the second loss based at least in part on the estimated amount of the deterministic orders to be canceled.

11. The one or more non-transitory computer-readable storage media of claim 10, wherein the deterministic orders are generated based at least in part on subscriptions for the item placed at the second ordering channel, wherein the amount of the deterministic orders is determined based at least in part on the subscriptions, and wherein the expected amount of the random orders is generated based at least in part on historical data associated with placing random orders for the item at the first ordering channel.

12. The one or more non-transitory computer-readable storage media of claim 5, wherein computing the first loss and the second loss comprises:
determining, based at least in part on the value for the look ahead window, a first amount of the deterministic orders to fulfill subscriptions for the item during a planning horizon;
estimating a second amount of the random orders to be placed during the planning horizon;
determining a stock-out point in time occurring during the planning horizon based at least in part on the first amount of deterministic orders, the second amount of random orders, and a potential quantity of the units the item to be stored in storage during the planning horizon, wherein the stock-out point in time indicates a time after which no units of the item are available from the storage; and
computing the first loss and the second loss based at least in part on the stock-out point.

13. The one or more non-transitory computer-readable storage media of claim 5, wherein generating the decision to store the units of the item comprises:
determining a cost associated with storing the units of the item in storage associated with the network-based resource;
determining revenue associated with offering, based at least in part on the first ordering channel and the second ordering channel, the units of the item from the storage; and
adjusting a quantity of the units of the item to be stored in the storage based at least in part on balancing the first loss, the second loss, the cost, and the revenue.

14. A system comprising:
a memory that stores computer-executable instructions and a database; and
a processor configured to access the memory and execute the computer-executable instructions to at least:
access data associated with a first ordering channel and a second ordering channel, the first ordering channel enabling random orders to be placed for an item offered at a network-based resource from a storage space, the second ordering channel enabling deterministic orders to be generated for the item offered at the network-based resource from the storage space, the first ordering channel and the second ordering channel share storage in the storage space, the database tracking orders of the item for both the first ordering channel and the second ordering channel, and the system controlling decisions about inventorying the item in the storage;
generate, based at least in part on the data that is accessed, a deterministic order associated with the second ordering channel, the deterministic order generated at a point in time based at least in part on a look ahead window, the look ahead window indicating a shift in time at which the deterministic orders of the item can be automatically generated;
compute, based at least in part on the look ahead window, a first loss associated with losing at least one of random orders and a second loss associated with canceling at least the deterministic order; and
generate a decision to inventory a quantity of the item so that the network-based resource can offer the item as available, the decision generated based at least in part on the first loss and the second loss, the decision causing the quantity of the item to be stored in the storage in support of shared usage of the storage by the first ordering channel and the second ordering channel.

15. The system of claim 14, wherein determining the second loss comprises:
computing a likelihood that the deterministic order is canceled based at least in part on a first expected realization of the random orders and on a second expected realization of a planning horizon within which the random orders are to be placed; and
integrating, over the deterministic orders of the second ordering channel, the likelihood with likelihoods of remaining deterministic orders being canceled, the remaining deterministic orders generated based at least in part on the look ahead window and the second expected realization of the planning horizon.

16. The system of claim 14, wherein determining the first loss and the second loss comprises:
setting the quantity of the item to an initial value;
determining a demand based at least in part on the deterministic orders of the second ordering channel and the look ahead window;
generating potential realizations of the random orders and other potential realizations of a planning horizon within which the random orders are to be placed, wherein individual potential realizations are associated with corresponding probabilities; and
computing the first loss and the second loss based at least in part on the initial value, the demand, the potential realizations, the other potential realizations, and the corresponding probabilities.

17. The system of claim 14, wherein the computer-executable instructions, when executed by the processor, further configure the processor to at least:
detect a trigger event; and
update the decision based at least in part on splitting the quantity in at least a first quantity of the item to be inventoried during a time period and a second quantity of the item to be inventoried during another time period.

18. The system of claim 17, wherein the trigger event comprises a spike in demand associated with the deterministic orders, and wherein a total of the first quantity and the second quantity is smaller than the quantity of the item.

19. The system of claim 17, wherein the first quantity is used to fulfill a portion of the random orders and a portion of the deterministic orders during the period of time, and wherein the second quantity is used to fulfill a remaining portion of the deterministic orders only during the other time period with a reduced risk of canceled deterministic orders in the other time period.

20. The system of claim 17, wherein the first quantity is computed based at least in part on:
estimating a first amount of the random orders to be placed during the time period;
determining a second amount of the deterministic orders to be fulfilled during the time period; and
updating the first loss and the second loss based at least in part on the first amount and the second amount, and
wherein the second quantity is computed based at least in part on a remaining amount of the deterministic orders to be fulfilled during the other time period.
